(19) United States
(12) Patent Application Publication
(10) Pub. No.: US 2015/0193424 A1
(43) Pub. Date: Jul. 9, 2015

(54) METHOD OF CHANGING DYNAMIC SCREEN LAYOUT AND ELECTRONIC DEVICE

(71) Applicant: Samsung Electronics Co., Ltd., Suwon-si (KR)

(72) Inventors: Sang-Yup LEE, Gwangju-si (KR); Se-Jun SONG, Seoul (KR); Soon-Hyun CHA, Anyang-si (KR)

(21) Appl. No.: 14/591,426

(22) Filed: Jan. 7, 2015

Related U.S. Application Data
(60) Provisional application No. 61/924,548, filed on Jan. 7, 2014.

(30) Foreign Application Priority Data
Mar. 26, 2014 (KR) 10-2014-0035245

(51) Int. Cl. G06F 17/24; G06F 3/0484

(52) U.S. Cl. CPC G06F 17/248; G06F 3/0484

(57) ABSTRACT

A method of changing a dynamic screen layout and an electronic device are provided. The method includes selecting at least two content items at least partially based on setting information associated with the content and characteristics of an application displaying the content, and providing the selected at least two content items. Furthermore, other embodiments can be made.

### CROSS-REFERENCE TO RELATED APPLICATION(S)

This application claims the benefit under 35 U.S.C. §119(e) of a U.S. Provisional application filed on Jan. 7, 2014 in the U.S. Patent and Trademark Office and assigned Ser. No. 61/924,548, and under 35 U.S.C. §119(a) of a Korean patent application filed on Mar. 26, 2014 in the Korean Intellectual Property Office and assigned Serial number 10-2014-0035245, the entire disclosure of each of which is hereby incorporated by reference.

### TECHNICAL FIELD

The present disclosure relates to an electronic device. More particularly, the present disclosure relates to a user interface configuration.

### BACKGROUND

In general, portable terminals have been widely used on the basis of mobility. Portable terminals can support various user functions as well as mobile communication functions, and users can operate the aforementioned various functions using the portable terminals.

Portable terminals provide various applications, and the applications include widgets. In recent years, user interface type applications such as a clock application, a calendar application, a memo application, a search application, a map application, a news application, a live camera application, and the like may be manufactured and provided to the users, in which users can access content provided by the applications without separately executing the applications.

The above information is presented as background information only to assist with an understanding of the present disclosure. No determination has been made, and no assertion is made, as to whether any of the above might be applicable as prior art with regard to the present disclosure.

### SUMMARY

When a request for displaying a widget on a screen is received according to a user input, the portable terminals display the widget which has a preconfigured size and includes some data.

The portable terminals cannot change the size of the widget or the data displayed on the widget according to the user input, and, therefore, it is difficult to provide a widget having various configurations to the users.

Aspects of the present disclosure are to address at least the above-mentioned problems and/or disadvantages and to provide at least the advantages described below. Accordingly, an aspect of the present disclosure is to provide a method of using an electronic device and an electronic device, which can change characteristics of an application according to a user input and provide various applications according to the changed characteristics of the application.

In accordance with an aspect of the present disclosure, a method of using an electronic device is provided. The method includes selecting at least two content items at least partially based on setting information associated with the at least two content items and characteristics of an application displaying the content and providing the selected at least two content items.

In accordance with another aspect of the present disclosure, an electronic device is provided. The electronic device includes a display functionally connected with the electronic device and configured to display an application and a processor configured to select at least two content items at least partially based on setting information associated with the at least two content items and characteristics of an application displaying the content and to provide the selected at least two content items.

As described above, the present disclosure provides a method of using an electronic device and an electronic device, which can change characteristics of an application according to a user input, and change an arrangement of content displayed on the application or transform the content according to the changed characteristics of the application, thereby providing various pieces of information to users.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a network environment including an electronic device according to an embodiment of the present disclosure;

FIG. 2 illustrates a relationship between an electronic device including an application configuring module and an application provider according to an embodiment of the present disclosure;

FIG. 3 is a block diagram illustrating a configuration of layout information according to an embodiment of the present disclosure;

FIG. 4 illustrates an operation of transferring data to an application provider according to an embodiment of the present disclosure;

FIG. 5 illustrates an operation in which a home screen module receives data from an application provider according to an embodiment of the present disclosure;

FIGS. 6A and 6B are flowcharts illustrating an operation of an application according to an embodiment of the present disclosure;

FIGS. 7A, 7B, and 7C illustrate a technology according to an embodiment of the present disclosure;

FIGS. 8A and 8B illustrate a technology according to an embodiment of the present disclosure;

FIGS. 9A and 9B illustrate an operation of an application depending on a user input according to an embodiment of the present disclosure;

FIGS. 10A, 10B, and 10C illustrate an operation of an application depending on a user input according to an embodiment of the present disclosure;

FIG. 11 illustrates a method of configuring a template according to an embodiment of the present disclosure;

FIG. 12 illustrates a method of configuring a template according to an embodiment of the present disclosure;

FIGS. 13A and 13B illustrate a method of displaying application elements depending on a user input according to an embodiment of the present disclosure;

FIG. 14 illustrates a method of configuring a template according to an embodiment of the present disclosure;

FIG. 15 illustrates an image to be displayed on an application according to an embodiment of the present disclosure;

FIGS. 16A and 16B illustrate a method of displaying application elements depending on a user input according to an embodiment of the present disclosure;

FIGS. 17A and 17B illustrate a method of displaying application elements depending on a user input according to an embodiment of the present disclosure;

FIGS. 18A and 18B illustrate a method of displaying application elements depending on a user input according to an embodiment of the present disclosure;

FIGS. 19A and 19B illustrate a method of displaying application elements depending on a user input according to an embodiment of the present disclosure;

FIGS. 20A, 20B, and 20C illustrate a method of displaying application elements depending on a user input according to an embodiment of the present disclosure;

FIGS. 21A, 21B, and 21C illustrate a method of displaying application elements depending on a user input according to an embodiment of the present disclosure;

FIGS. 22A and 22B illustrate a method of displaying application elements depending on a user input according to an embodiment of the present disclosure;

FIGS. 23A and 23B illustrate a method of displaying application elements depending on a user input according to an embodiment of the present disclosure;

FIGS. 24A and 24B illustrate a method of displaying application elements depending on a user input according to an embodiment of the present disclosure;

FIGS. 25A and 25B illustrate a method of displaying action elements of an application depending on a user input according to an embodiment of the present disclosure;

FIGS. 26A and 26B illustrate a method of displaying action elements of an application depending on a user input according to an embodiment of the present disclosure;

FIGS. 27A, 27B, 27C, and 27D illustrate a method of displaying action elements of an application depending on a user input according to an embodiment of the present disclosure;

FIGS. 28A, 28B, 29A, 29B, and 29C illustrate methods of displaying application elements depending on a user input according to an embodiment of the present disclosure;

FIGS. 30A and 30B illustrate a method of displaying application elements depending on a user input in a lock screen state according to an embodiment of the present disclosure; and

FIG. 31 is a block diagram of an electronic device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the present disclosure. Accordingly, it should be apparent to those skilled in the art that the following description of various embodiments of the present disclosure is provided for illustration purposes only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “or” in various embodiments of the disclosure means the inclusion of at least one or all of the disclosed elements. For example, “A or B” may mean any one of the inclusion of A, the inclusion of B, or the inclusion of A and B.

The expressions such as “first,” “second,” or the like used in various embodiments of the present disclosure may modify various component elements in the various embodiments but may not limit corresponding component elements. The expressions may be used for distinguishing one component from other components. For example, a first user device and a second user device indicate different user devices although both of them are user devices. For example, without departing from the scope of the present disclosure, a first structural element may be named a second structural element. Similarly, the second structural element also may be named the first structural element.

When it is stated that a component is “coupled to” or “connected to” another component, the component may be directly coupled or connected to another component or a new component may exist between the component and another component. In contrast, when it is stated that a component is directly “coupled to” or “connected to” another component, a new component does not exist between the component and another component.

The terms used in various embodiments of the present disclosure are only examples for describing a specific embodiment but do not limit the various embodiments of the present disclosure. Singular forms are intended to include plural forms unless the context clearly indicates otherwise.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

An electronic device according to various embodiments of the present disclosure may be a device having a display function. For example, the electronic devices may include at least one of smart phones, tablet Personal Computers (PCs), mobile phones, video phones, e-book readers, desktop PCs, laptop PCs, netbook computers, Personal Digital Assistants (PDAs), Portable Multimedia Players (PMPs), MP3 players, mobile medical devices, cameras, wearable devices {e.g., Head-Mounted-Devices (HMDs) such as electronic glasses}, electronic clothes, electronic bracelets, electronic necklaces, electronic appcessories, electronic tattoos, or smart watches.

The electronic device may be a smart home appliance with a display function. The smart home appliance as an example of the electronic device may include at least one of, for example, a television, a Digital Video Disk (DVD) player, an audio, a refrigerator, an air conditioner, a vacuum cleaner, an oven, a microwave oven, a washing machine, an air cleaner, a set-top box, a TV box (e.g., Samsung HomeSync™, Apple TV™, or Google TV™), a game console, an electronic dictionary, an electronic key, a camcorder, and an electronic picture frame.

The electronic devices may include at least one of various medical devices {e.g., a Magnetic Resonance Angiography (MRA), a Magnetic Resonance Imaging (MRI), a Computed Tomography (CT) machine, and an ultrasonic machine}, navigation devices, Global Positioning System (GPS) receivers, Event Data Recorders (EDR), Flight Data Recorders (FDR), vehicle infotainment devices, electronic devices for ships (e.g., navigation devices for ships, and gyro-compasses), avionics, security devices, automotive head units, robots for home or industry, Automatic Teller's Machines (ATMs) in banks, or Point Of Sales (POS) in shops.

The electronic device may include, or be incorporated in, at least one of furniture or a part of a building/structure, an electronic board, an electronic signature receiving device, a projector, and various types of measuring devices (for example, a water meter, an electric meter, a gas meter, a radio wave meter and the like) including a display function. Electronic devices according to various embodiments of the present disclosure may be one or more combinations of the above-described devices. In addition, electronic devices according to various embodiments of the present disclosure may be flexible devices. However, electronic devices according to various embodiments of the present disclosure are not limited to the above-described devices.

Hereinafter, the electronic device according to various embodiments will be described with reference to the accompanying drawings. The term “a user” used in various embodiments may refer to a person who uses electronic devices or a device (e.g., an artificial intelligence electronic device) that uses electronic devices.

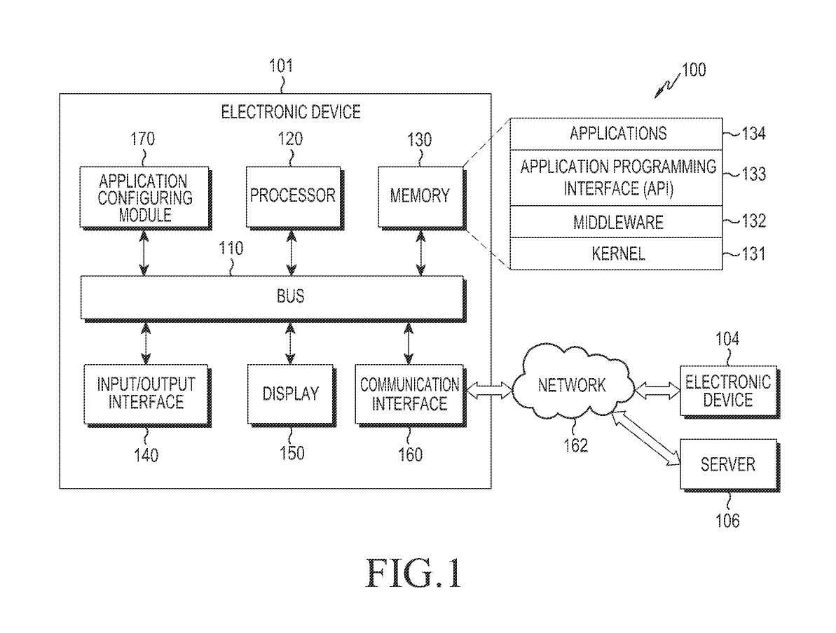

FIG. 1 illustrates a network environment including an electronic device according to various embodiments of the present disclosure.

Referring to FIG. 1, the network environment includes electronic devices 101 and 104, a server 106, and a network 162. The electronic device 101 may include a bus 110, a processor 120, a memory 130, an input/output interface 140, a display 150, a communication interface 160, and an application configuring module 170.

The bus 110 may be a circuit that connects the aforementioned elements and transfers communications (e.g., a control message) between the aforementioned elements.

For example, the processor 120 may receive instructions from the aforementioned other elements (e.g., the memory 130, the input/output interface 140, the display 150, the communication interface 160, and the application configuring module 170) through the bus 110, decipher the received instructions, and perform calculation or data processing according to the deciphered instructions.

The memory 130 may store instructions or data which is received from the processor 120 or other elements (e.g., the input/output interface 140, the display 150, the communication interface 160, and the application configuring module 170) or created by the processor 120 or other elements. The memory 130 may include programming modules such as a kernel 131, a middleware 132, an Application Programming Interface (API) 133, applications 134, and the like. Each of the programming modules described above may be configured with software, firmware, hardware, or combinations of two or more thereof.

The kernel 131 may control or manage system resources (e.g., the bus 110, the processor 120, the memory 130, and the like) used to perform operations or functions implemented in the remaining programming modules, for example, the middleware 132, the API 133, and the applications 134. Furthermore, the kernel 131 may provide an interface through which the middleware 132, the API 133, and the applications 134 may access individual elements of the electronic device 101 to control or manage them.

The middleware 132 may serve as an intermediary such that the API 133 or the applications 134 communicate with the kernel 131 to transmit/receive data. Furthermore, in regard to task requests received from the applications 134, the middleware 132 may perform a control (e.g., scheduling or load balancing) for the task requests using, for example, a method of assigning a priority for using the system resources (e.g., the bus 110, the processor 120, and the memory 130) of the electronic device 101 to at least one of the applications 134.

The API 133 is an interface through which the applications 134 may control functions provided by the kernel 131 and the middleware 132, and may include at least one interface or function (e.g., instruction) for file control, window control, image processing, or text control.

According to the various embodiments of the present disclosure, the applications 134 may include a Short Message Service (SMS)/Multimedia Message Service (MMS) application, an e-mail application, a calendar application, an alarm application, a health care application (e.g., an application for measuring a work rate or a blood sugar), an environment information application (e.g., an application for providing atmospheric pressure, humidity, or temperature information). Additionally or alternately, the application 134 may be an application related to an information exchange between the electronic device 101 and an external electronic device (e.g., an electronic device 104). The application related to the information exchange may include, for example, a notification relay application for relaying specific information to the external electronic device or a device management application for managing the external electronic device.

For example, the notification relay application may include a function of relaying notification information created by other applications of the electronic device 101 (e.g., the SMS/MMS application, the e-mail application, the health care application, and the environment information application) to the external electronic device (e.g., the electronic device 104). Additionally or alternately, the notification relay application may, for example, receive notification information from the external electronic device (e.g., the electronic device 104), and may provide the received notification information to a user. For example, the device management application may manage (e.g., install, delete, or update) a function for at least some parts of the external electronic device (e.g., the electronic device 104) communicating with the electronic device 101 (e.g., a function of turning on/off the external electronic device itself (or some components) or a function of adjusting luminance (or a resolution) of the display), applications operating in the external electronic device, or services provided by the external electronic device (e.g., a call service and a message service).

According to various embodiments of the present disclosure, the applications 134 may include an application designated according to an attribute (e.g., a type) of the external electronic device (e.g., the electronic device 104). For example, in a case where the external electronic device is an MP3 player, the application 134 may include an application related to the reproduction of music. Similarly, in a case where the external electronic device is a mobile medical appliance, the application 134 may include an application related to health care. According to one embodiment, the applications 134 may include at least one of an application designated to the electronic device 101 and an application received from the external electronic device (e.g., a server 106 or the electronic device 104).

The input/output interface 140 may transfer instructions or data input from a user through an input/output device (e.g., a sensor, a keyboard, or a touch screen) to, for example, the processor 120, the memory 130, the communication interface 160, or the application configuring module 170 through the bus 110. For example, the input/output interface 140 may provide, to the processor 120, data for a user's touch which is input through the touch screen. Furthermore, through the input/output device (e.g., a speaker or a display), the input/output interface 140 may output instructions or data received from the processor 120, the memory 130, the communication interface 160, or the application configuring module 170 through the bus 110. For example, the input/output interface 140 may output voice data processed through the processor 120 to a user through a speaker.

The display 150 may display various pieces of information (e.g., multimedia data or text data) to a user.

The communication interface 160 may connect communication between the electronic device 101 and the external electronic device (e.g., the electronic device 104 or the server 106). For example, the communication interface 160 may be connected to a network 162 through wireless or wired communication to communicate with the external device. The wireless communication may include at least one of, for example, Wi-Fi, BlueTooth (BT), Near Field Communication (NFC), a GPS, and cellular communication (e.g., Long Term Evolution (LTE), Long Term Evolution-Advanced (LTE-A), Code Division Multiple Access (CDMA), Wideband CDMA (WCDMA), Universal Mobile Telecommunication System (UMTS), Wireless Broadband (WiBro), or Global System for Mobile communication (GSM)). The wired communication may include at least one of, for example, Universal Serial Bus (USB), High Definition Multimedia Interface (HDMI), Recommended Standard 232 (RS-232), and Plain Old Telephone Service (POTS).

According to an embodiment of the present disclosure, the network 162 may be a communication network. The communication network may include at least one of a computer network, the Internet, the Internet of things, and a telephone network. According to one embodiment, a protocol (e.g., a transport lay protocol, data link layer protocol, or a physical layer protocol) for communication between the electronic device 101 and the external device may be supported by at least one of the applications 134, the application programming interface 133, the middleware 132, the kernel 131, and the communication interface 160.

The application configuring module 170 may process at least some information acquired from other elements (e.g., the processor 120, the memory 130, the input/output interface 140, and the communication interface 160), and may provide the processed information to a user through various methods. For example, the application configuring module 170 may select at least two content items displayed on an application at least partially based on setting information associated with the content and characteristics of the application displaying the content, using the processor 120 or independently of the processor 120, and may provide the selected at least two content items.

According to various embodiments of the present disclosure, an application may include a widget. The content may mean data including elements configuring the application. Furthermore, the setting information may include at least one of display information for the content displayed on the application, action information for an executable action corresponding to an arrangement change of the content, attribute information used to change content which will be displayed on the application, and template type information containing the type or number of the content displayed on the application. According to various embodiments of the present disclosure, characteristics of an application may include at least one of a size of the application, display for the application on a lock screen, and display for the application on a notification screen. In various embodiments of the present disclosure, the descriptions are not limited to contents thereof, and may be diversely expressed.

When an input for changing the characteristics of the application is received, the application configuring module 170 may change the characteristics of the application, and may change the at least two content items at least partially based on the changed characteristics of the application. The input may include at least one of an input for changing a size of the application and an input for page turning of the application.

According to various embodiments of the present disclosure, the application configuring module 170 may change an arrangement of the content displayed on the application according to the changed characteristics of the application. Furthermore, the application configuring module 170 may transform the content displayed on the application according to the changed characteristics of the application.

According to various embodiments of the present disclosure, the electronic device may include a display for displaying an application, and a processor for selecting and providing at least two content items at least partially based on setting information associated with the content and characteristics of the application displaying the content.

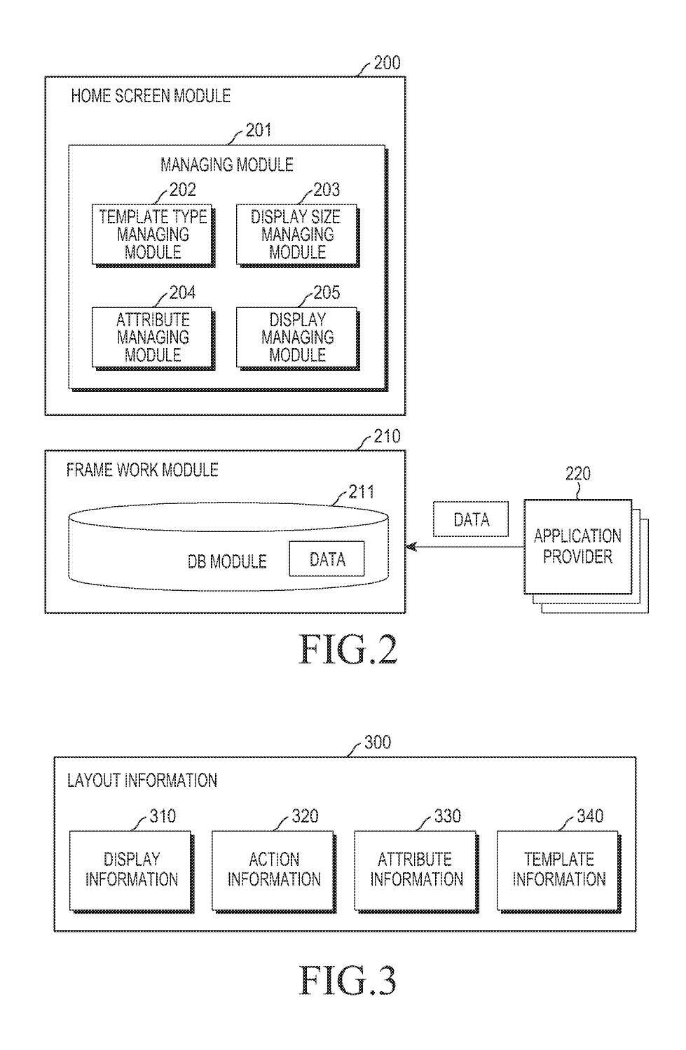

FIG. 2 illustrates a relationship between an electronic device including an application configuring module and an application provider according to the various embodiments of the present disclosure.

Referring to FIG. 2, the application configuring module 170 may include a home screen module 200 and a frame work module 210.

The home screen module 200 may include a managing module 201 for managing a layout change of an application. The home screen module 200 is a configuration for displaying the contents of an application, and the configuration for displaying the contents of the application may be implemented in various forms. The layout means arrangement information for arranging elements configuring the application. The arrangement information may include the number, size, and location of a display region for displaying the element.

The home screen module 200 may display an application using application data received from an application provider 220. At this time, the received application data includes layout information and application elements such as an image, text, multimedia, a map, a Hypertext Markup Language (HTML) link, and the like which configure the application. According to the various embodiments of the present disclosure, layout information may include at least one of display information of application elements, template information including the type and the number of the application elements, attribute information for determining a layout, and action information for performing a specific process.

When an input for changing a layout of an application is entered, the home screen module 200 may select a suitable layout and apply the selected layout to the application according to a situation of the application arranged in the home screen module 200 based on layout information of the application provider 220 provided from a DB module 211 within the frame work module 210. The layout change may be performed through the managing module 201 within the home screen module.

The managing module 201 may include at least one of a template type managing module 202, a display size managing module 203, an attribute managing module 204, and a display managing module 205. The managing module 201 may be configured to include at least one of the modules, or may also be configured to perform all operations of the modules without including the modules.

The template type managing module 202 may manage a plurality of layouts for each template, and may determine a layout suitable to display on the home screen module 200 based on layout information received from the application provider 220.

A plurality of layouts may be mapped to the single template and may be managed such that different types of layouts correspond to each other according to the size of the application. For example, in the management of the layouts, a layout corresponding to a small-sized application may be managed to correspond to a layout corresponding to a large-sized application or layouts in the form of scrolling leftward and rightward may be managed to correspond to each other.

In a specific example, when the application provider 220 transfers, to the electronic device 101, layout information for an application which outputs the contents of an e-mail in the form of being scrolled leftward and rightward, the template type managing module 202 within the electronic device 101 may configure an application in the form of being scrolled leftward and rightward to display the configured application through the display 150, based on the received layout information. When a leftward or rightward scroll input is entered through the input/output interface 140, the template type managing module 202 may display the contents of an e-mail before or after the first displayed e-mail through the application. Furthermore, the template type managing module 202 may also divide the contents of one e-mail into a plurality of content to display the divided content in a leftward and rightward scroll form.

The template type managing module 202 may determine a layout in view of the type of application. For example, in a case of an application for displaying an e-mail, when layout information is received from the application provider 220, the template type managing module 202 may display a title of the e-mail, a sender, and a sending time in one display region, and may select a layout configured with two display regions to display action buttons for displaying detailed information of the e-mail together with the contents of the e-mail in another display region.

In another example, when layout information for a plurality of e-mails is received from application providers providing the plurality of e-mail applications, the template type managing module 202 may display one of the plurality of e-mails in one display region, and may select a layout capable of displaying, on the display region, an identifier for notifying that there are e-mails provided from different application providers. Accordingly, when a touch or click event is made on the displayed identifier, the template type managing module 202 may display another e-mail other than the displayed e-mail among the plurality of e-mails through the application.

The display size managing module 203 may identify a display size including at least one of a size of a region where an application is displayed on the display 150 and a size of the application on which application elements may be accurately displayed, and may determine a layout suitable for displaying the application based on the identified display size. For example, the display size managing module 203 may determine a layout having a preconfigured reference size when a size of a region for displaying an application is small, and may determine a layout having a size larger than the preconfigured reference size when the size of the region for displaying the application is large.

The attribute managing module 204 may select application elements to be displayed through an application based on attribute information of the application provided from the application provider 220. The attribute managing module 204 may select the application elements to be displayed in response to the determined layout when the application is displayed, and may display the selected application elements.

For example, the attribute information may include a maximum or minimum size of an application, a color of text in a case where application elements include the text, and a Region of Interest (ROI) of an image in a case where application elements include the image. According to an embodiment of the present disclosure, the ROI means a location of a region of interest within an image. This helps the attribute managing module 204 display an entire image when a layout corresponding to the enlarged size is determined, and helps the attribute managing module 204 display only the image in a region corresponding to the ROI when a layout corresponding to the preconfigured reference size is determined.

A plurality of ROIs may be configured on one image. In this case, the attribute managing module 204 may display an image of regions corresponding to the plurality of ROIs according to a layout. For example, in an application displaying a movie poster image including a vehicle and an actor, when one ROI corresponds to the vehicle and another ROI corresponds to the actor, the attribute managing module 204 may display an image corresponding to the vehicle or actor on the application according to a layout.

In addition, in a case where the attribute information includes a plurality of ROIs for one image, the attribute managing module 204 may display an image corresponding to the ROI selected by a user among the plurality of ROIs on the application.

In another example, when attribute information for displaying schedule content in black in a layout corresponding to a preconfigured reference size and displaying the schedule content in red in a layout corresponding to an enlarged size is received from the application provider 220 providing a schedule application, the attribute managing module 204 may display the schedule contents in black or red according to the layout determined based on the attribute information.

The display managing module 205 may process application elements to be displayed according to a layout determined based on at least one of template information and attribute information of an application and a display size, and may display the processed application elements on the home screen module 200.

The frame work module 210 may transmit/receive data to/from the external application provider 220, and may include the DataBase (DB) module 211 that stores application data received from the application provider 220. When updating layout information, the frame work module 210 may notify the home screen module 200 of the update of the layout information to allow the home screen module 200 to update an application based on the updated layout information.

The application provider 220 may provide application data including application elements and layout information.

According to an embodiment of the present disclosure, the electronic device may include a display that is functionally connected with the electronic device to display an application, and a processor that selects at least two content items at least partially based on setting information associated with the content and characteristics of the application for displaying the content and provides the selected at least two content items.

FIG. 3 is a block diagram illustrating a configuration of layout information according to various embodiments of the present disclosure.

Referring to FIG. 3, the layout information 300 may be configured with at least one of display information 310, action information 320, attribute information 330, and template type information 340.

The display information 310 is information for displaying application elements configuring an application, and the template information is at least one of a type, the number, and an action of the elements configuring the application based on each layout. For example, in a case where an application is configured with elements such as an image and text, the template information may include information representing one image, two sections of text, and one action associated with the image. The attribute information is information for selecting an application element highlighted in a display region in response to a determined layout. The action information is information for defining a function connected with the display information, and may include, for example, functions such as making a call, sending an e-mail, web page access, payment, and the like.

According to various embodiments of the present disclosure, an electronic device may include a display that is functionally connected with the electronic device to display an application, and a processor that selects at least two content items at least partially based on setting information associated with the content and characteristics of the application for displaying the content and provides the selected at least two content items.

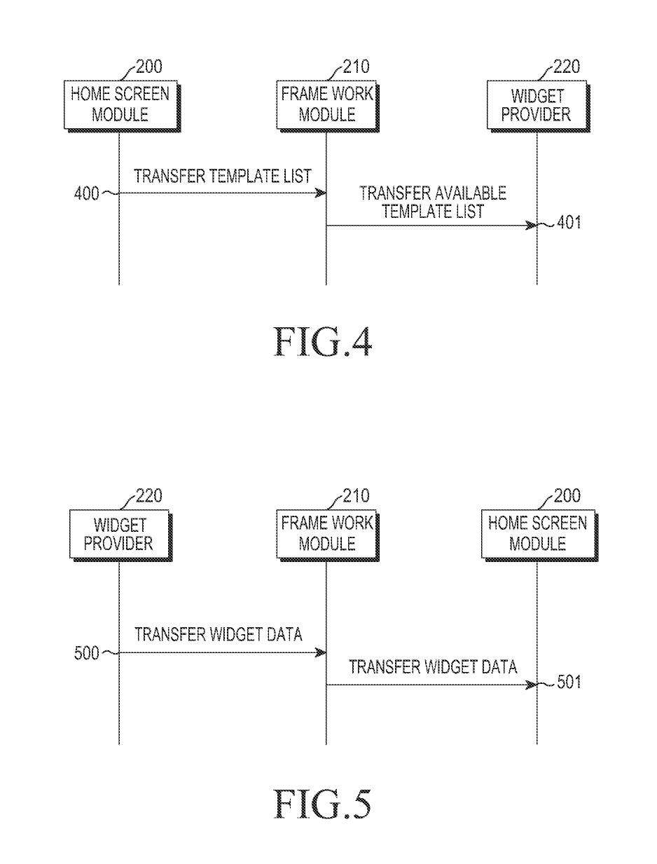

FIG. 4 illustrates an operation of transferring data to an application provider according to an embodiment of the present disclosure.

Referring to FIG. 4, a home screen module 200 transfers template lists for an application which may be displayed by the home screen module 200 to the frame work module 210 in operation 400, and the frame work module 210 transfers an available template list among the template lists to an application provider 220 in operation 401. According to an embodiment of the present disclosure, a method of using an electronic device may include an operation of selecting at least two content items at least partially based on setting information associated with the content and characteristics of the application displaying the content and an operation of providing the selected at least two content items.

FIG. 5 illustrates an operation in which a home screen module receives data from an application provider according to an embodiment of the present disclosure.

Referring to FIG. 5, an application provider 220 determines application data to transfer to a home screen module 200 with reference to the received template list in operation 500, and may transfer the determined application data to a frame work module 210. In operation 501, the frame work module 210 transfers the received application data to the home screen module 200. The home screen module 200 may display an application based on the received application data. According to the various embodiments of the present disclosure, template information or a template list contained in layout information within the application data may be used to define application elements and actions desired to be displayed on the application. For example, in the template information or the template list, the number of application elements such as an image, text, and an action may be defined, and the home screen module 200 may display an application using the template information or the template list based on a rule designated for a situation of the application.

According to an embodiment of the present disclosure, a method of using an electronic device may include an operation of selecting at least two content items at least partially based on setting information associated with the content and characteristics of the application displaying the content and an operation of providing the selected at least two content items.

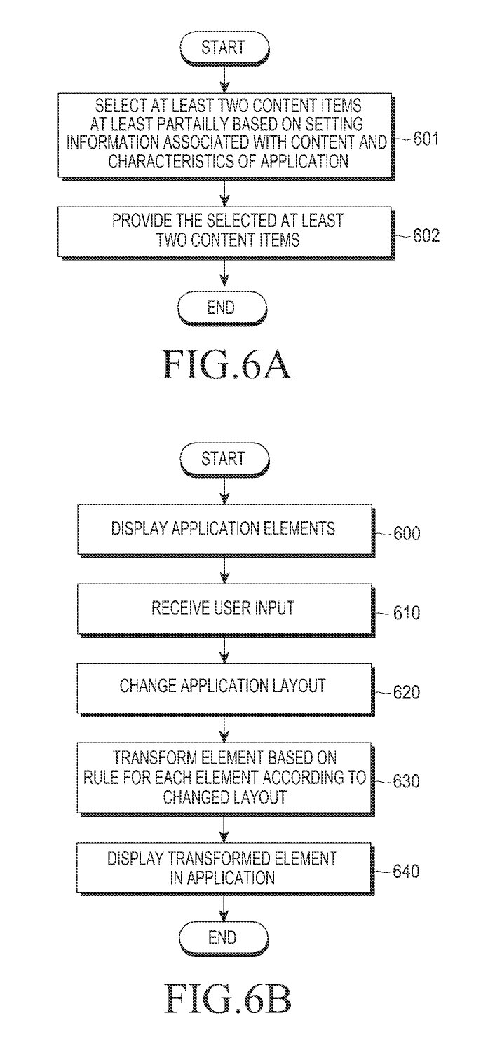

FIGS. 6A and 6B are flowcharts illustrating an operation of an application according to an embodiment of the present disclosure.

Referring to FIGS. 6A and 6B, in operation 601 of FIG. 6A, a home screen module 200 may select at least two content items at least partially based on setting information associated with the content and characteristics of an application.

In operation 602, the home screen module 200 may provide the selected at least two content items.

Accordingly, the home screen module 200 may change the at least two content items, and may provide at least one other content items at least partially based on the configured condition. Furthermore, the home screen module 200 may change a location of the at least two content items at least partially based on the configured condition, and may also provide another content at least partially based on the configured condition.

The home screen module 200 may change the characteristics of the application according to an input for changing the characteristics of the application, and may change the at least two content items at least partially based on the changed characteristics of the application. The input may include at least one of an input for changing a size of the application and an input for page turning of the application.

The home screen module 200 may change the size of the application when the input for changing the size of the application is received, and may turn a page of the application when the input for the page turning of the application is received.

The home screen module 200 may change an arrangement of the content displayed on the application according to the changed characteristics of the application, and may transform the content displayed on the application according to the changed characteristics of the application. According to an embodiment of the present disclosure, the characteristics of the application may include at least one of a size of the application, display for the application on a lock screen, and display for the application on a notification screen. Furthermore, the setting information may include at least one of display information for the content displayed on the application, action information for an executable action corresponding to the arrangement change of the content, attribute information used to change content which will be displayed on the application, and template type information containing the type or number of the content displayed on the application.

Referring to FIG. 6B, the home screen module 200 displays an application in operation 600, and receives a user input in operation 610.

In operation 620, when the received user input corresponds to an input for changing a layout of the application, the home screen module 200 selects a layout suitable to display thereon based on the layout information. Such a layout may be selected according to at least one of a type, the number, an amount and a size of application elements, and whether a group format is needed. For example, in a case where the application elements are large-sized images, the home screen module 200 may select a layout containing a display region for displaying the large-sized images. In a case where the application elements are images having low resolution, the home screen module 200 may also select a layout containing a display region for displaying the images having low resolution. Furthermore, in a case where a large amount of application elements are displayed on the application, the home screen module 200 may select a group type of layout which may be scrolled leftward and rightward.

In addition, the home screen module 200 may also determine in advance a layout to be changed according to the user input. For example, the home screen module 200 may select a first layout (layout_small_{—}1) having a basic size when a space where the application will be displayed is small, and may select a second layout (layout_extention_{—}2) having an extended size when a space where the application will be displayed is large. The home screen module 200 may select in advance the layout_small_{—}1 and the layout_extention_{—}2 based on template information, and may display the application using one of the selected layouts according to a user input.

The home screen module 200 transforms the application elements in response to the selected layout in operation 630, and may display the application containing the application elements transformed depending on the selected layout in operation 640. At this time, the application elements may include an image, text, multimedia, and the like.

According to an embodiment of the present disclosure, a method of using an electronic device may include an operation of selecting at least content items at least partially based on setting information associated with the content and characteristics of the application displaying the content and an operation of providing the selected at least two content items.

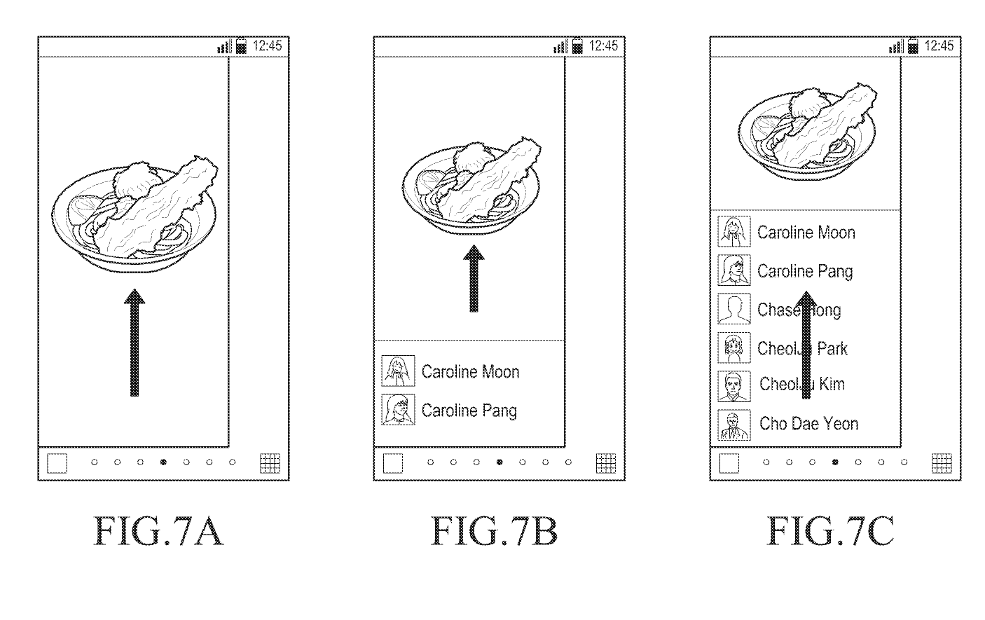

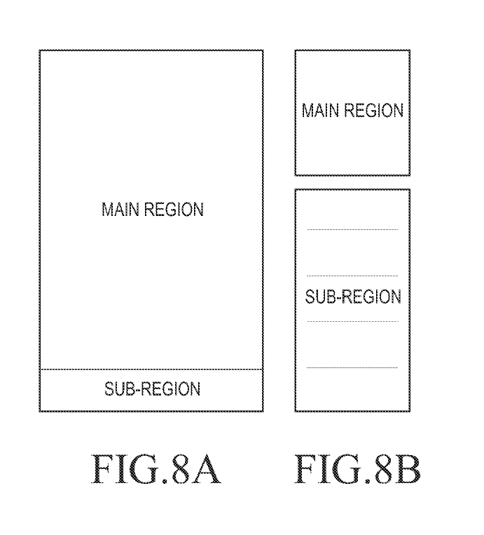

FIGS. 7A to 8B illustrate technologies according to an embodiment of the present disclosure.

Referring to FIGS. 7A-7C and 8A-8B, when a scroll operation is performed upward on an application as illustrated in FIGS. 7A to 7C, an electronic device 101 may reduce the size of an image displayed in the main region, and may enlarge areas of text displayed in a sub-region and display the enlarged text. For example, in a state in which the main region and a sub-region are displayed as illustrated in FIG. 8A, the size of the main region and the sub-region may be changed according to a user input as illustrated in FIG. 8B.

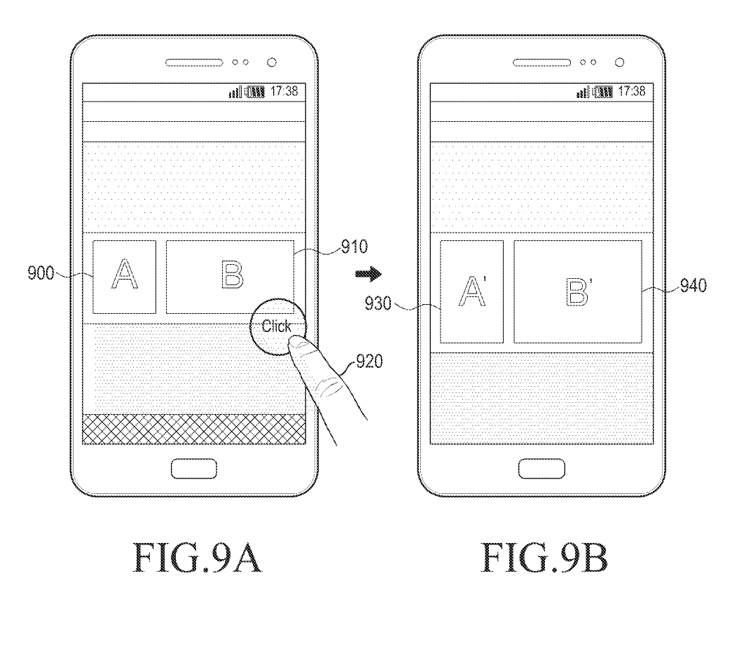

FIGS. 9A and 9B illustrate an operation of an application depending on a user input according to an embodiment of the present disclosure.

Referring to FIGS. 9A and 9B, as illustrated FIG. 9A, a home screen module 200 may display an application element A in a first display region 900 and an application element B in a second display region 910. The application elements may be an image, text, multimedia, an HTML link, a map, or the like. Each application element may be displayed differently depending on a size of the display region corresponding to a location where the application element is displayed.

For example, in a case where the application element is an image, the home screen module 200 may display the entire image or a partial region such as a ROI of the image according to the size of the display region.

In a case where the application element is text, the home screen module 200 may display the entirety of the text or a headline of the text according to the size of the display region. In a case where the application element is media, the home screen module 200 may display the entirety of the multimedia or a partial section of the multimedia according to the size of the display region. In a case where the application element is an HTML link, the home screen module 200 may display the entire address of the HTML link or a representative domain or image of the HTML address according to the size of the display region. In a case where the application element is a map, the home screen module 200 may display the map using different sizes according to the size of the display region.

If there is a user input 920 such as a touch on an application, the home screen module 200 determines whether the user input 920 is an input for changing a layout of the application. The input for changing the layout of the application may include a touch input, a leftward and rightward scroll input, and the like on the application. Furthermore, such an input may include various forms of inputs such as a spatial input, a voice input, a device slope, a bezel input, a side input, a hovering input, and the like.

The hovering input for the electronic device 101 may mean detecting a pointing object such as a finger, a touch pen, or a stylus pen without direct contact with a detection surface of a touch screen 140. An operation of moving or scrolling a touch proximate to the electronic device 101 rightward, leftward, downward, or upward may be determined as a designated gesture for the electronic device 101.

A side-touch for the electronic device 101 means detecting a user input on a bezel around the touch screen 140. A designated gesture may be determined for a user input around the electronic device 101.

When it is determined that the user input 920 is the input for changing the layout of the application, the home screen module 200 selects a layout based on layout information.

In a case where the application is to be enlarged by the selected layout, the home screen module 200 may enlarge the application and then display an application element A′ in a third display region 930 enlarged in correspondence to the enlarged application and an application element B′ in an enlarged fourth display region 940 as illustrated in FIG. 9B.

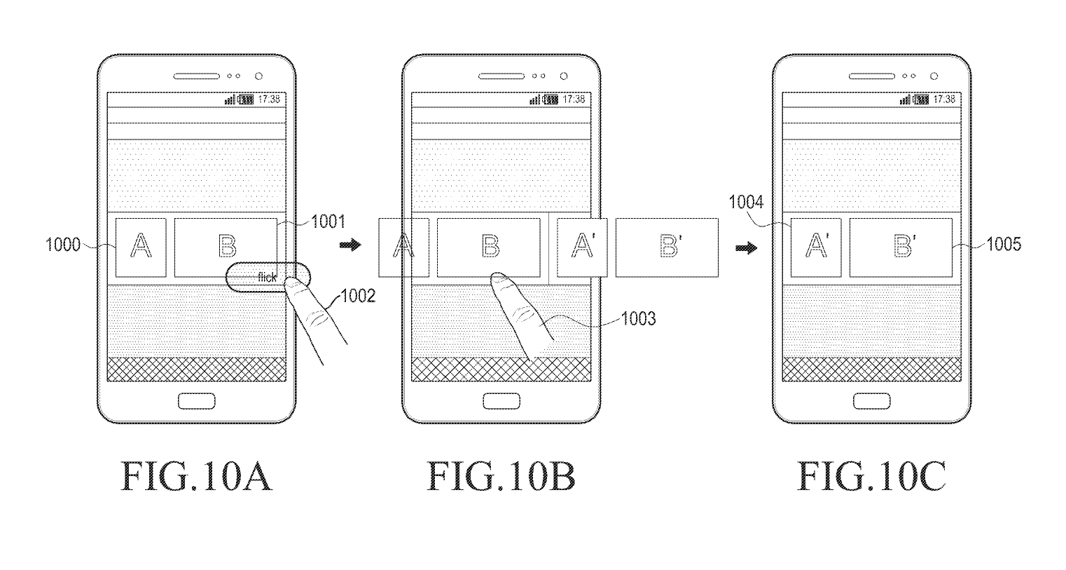

FIGS. 10A, 10B, and 10C illustrate an operation of an application depending on a user input according to an embodiment of the present disclosure.

Referring to FIGS. 10A-10C, when there is a leftward and rightward scroll input 1002 on an application including an application element A displayed in a first display region 1000 and an application element B displayed in a second display region 1001 as illustrated in FIG. 10A, a home screen module 200 selects a layout in response to the leftward and rightward scroll input 1002, in which case the application display regions are converted in a direction 1003 corresponding to the leftward and rightward scroll, and the home screen module 200 may display an application element A′ in a third display region 1004 and an application element B′ in a fourth display region 1005.

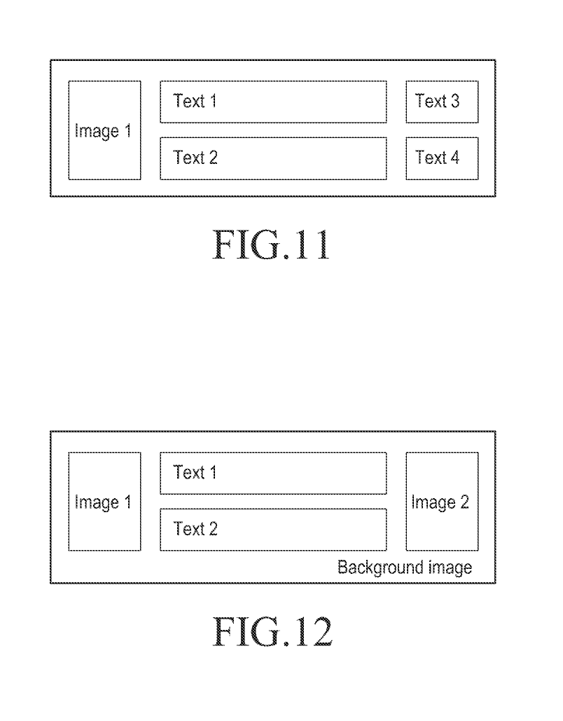

FIG. 11 illustrates a method of configuring a template according to an embodiment of the present disclosure.

Referring to FIG. 11, template information may include one image (Image 1) and four sections of text (Text 1, Text 2, Text 3, and Text 4), and a home screen module 200 may select a layout corresponding to the template information.

FIG. 12 illustrates a method of configuring a template according to an embodiment of the present disclosure.

Referring to FIG. 12, template information may include one background image, two images (Image 1 and Image 2), and two sections of text (Text 1 and Text 2), and a home screen module 200 may select a layout corresponding to the template information.

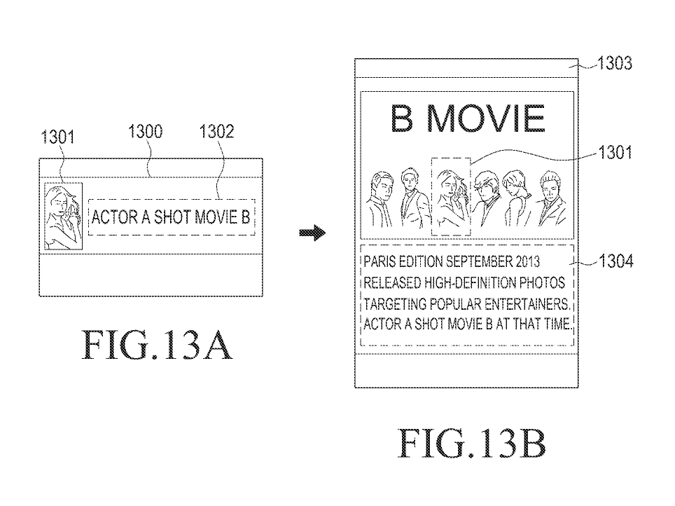

FIGS. 13A and 13B illustrate a method of displaying application elements depending on a user input according to an embodiment of the present disclosure.

Referring to FIG. 13A, a home screen module 200 may display an application 1300 configured with an actor image 1301 and text 1302 such as “Actor A shoots movie B”. When an input for changing a layout of the application is entered, the home screen module 200 may determine a layout to change based on layout information provided from an application provider 220, and may display the application using the determined layout. The determined layout may be an extended layout including a movie image 1303 and a movie article 1304 as illustrated in FIG. 13B. The actor image 1301 may be an image in a region corresponding to a ROI of the movie image 1303, and the text 1302 “Actor A shoot movie B” may be text corresponding to a headline of the movie article 1304 for the movie B.

For example, template information included in the layout information may include one movie image and two sections of text, namely, the headline “Actor A shoots Movie B” and the movie article “Paris Edition September 2013 releases high-definition photos targeting popular entertainers. Actor A shoots movie B at that time.”

Furthermore, attribute information included in the layout information may be exemplarily represented as follows.

ROI: origin (x, y)=(58, 70)

(width, height)=(180, 126)

According to an embodiment of the present disclosure, the aforementioned information may be stored in a DB module 211, and a frame work module 201 may transfer the updated information in the DB module 211 to the home screen module 200.

The home screen module 200 selects a layout suitable to display thereon using the above-described information, and in particular, a display size managing module 203 within the home screen module 200 may select a layout having a size suitable to display on the home screen module 200 based on the template information.

In order to display the application as illustrated in FIG. 13A, the home screen module 200 may select a layout based on a height and a width of an image for which a ROI is configured. In a case where the height and the width of the image for which the ROI is configured are smaller than a size of a screen, the home screen module 200 may select a layout including a thumbnail region capable of displaying a thumbnail.

In order to display text in a region other than the thumbnail region, the home screen module 200 may identify a height and a width for the region other than the thumbnail region and a length for two sections of text. The home screen module 200 may select the text “Actor A shoots movie B” which may be displayed in the region other than the thumbnail region, based on the identified height and width for the region other than the thumbnail region and the identified length for the two texts.

Thereafter, when an input for enlarging the size of the application is entered by a user, the display size managing module 203 within the home screen module 200 identifies the size of the enlarged application. If a ratio of a margin other than the region for displaying the thumbnail image is high in the enlarged application, the display size managing module 203 may configure such that an original image but not the image corresponding to the ROI is displayed.

When the input for enlarging the size of the application is entered, the home screen module 200 may configure such that the region corresponding to the ROI corresponds to a location of the original image when the application is enlarged. In addition, when displaying multimedia in different layouts, the home screen module 200 may convert a part of a thumbnail image of the multimedia to display the converted image in one layout, and may convert another part of the thumbnail image of the multimedia to display the converted image in another layout.

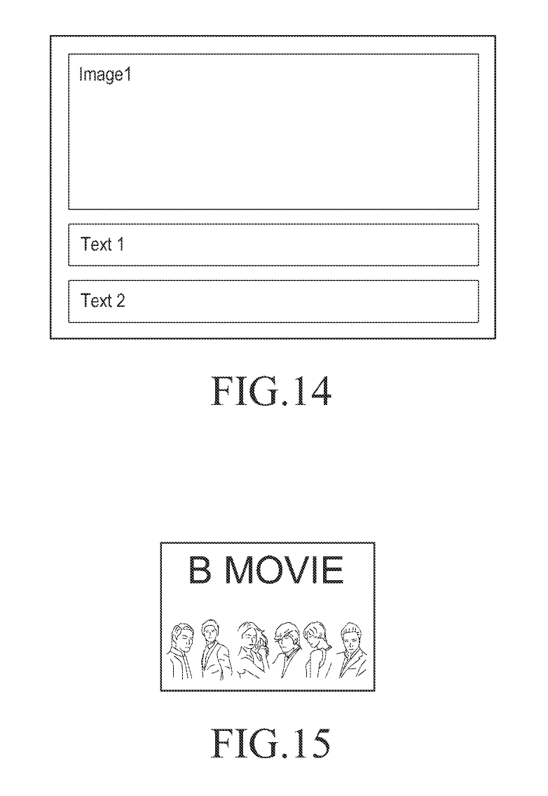

FIG. 14 illustrates a method of configuring a template according to an embodiment of the present disclosure.

Referring to FIG. 14, template information may include one image (Image 1) and two sections of text (Text 1 and Text 2). A home screen module 200 may select a layout corresponding to the template information.

FIG. 15 illustrates an image to be displayed on an application according to an embodiment of the present disclosure.

Referring to FIG. 15, an application according to an embodiment of the present disclosure may be configured and displayed as illustrated in FIG. 15.

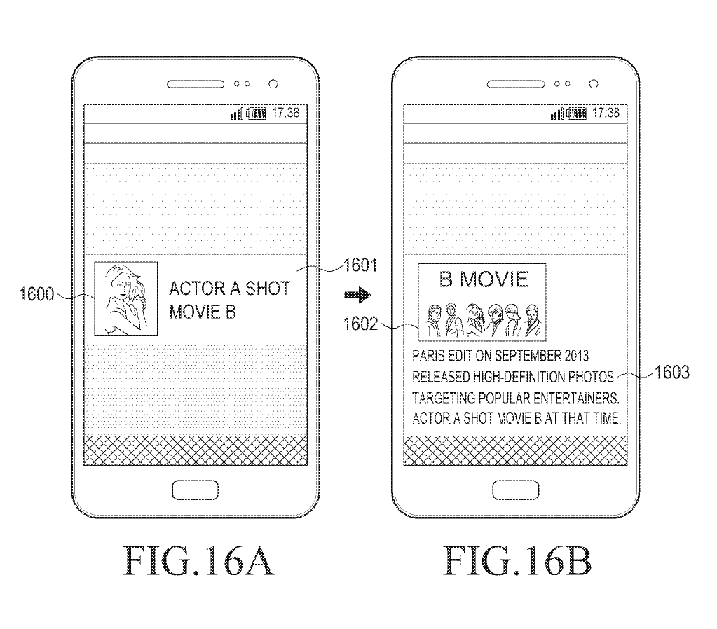

FIGS. 16A to 24B illustrate methods of displaying application elements depending on a user input according to various embodiments of the present disclosure.

Referring to FIGS. 16A and 16B, an application may include a first display region 1600 in which a first image is displayed and a second display region 1601 in which a first text is displayed. According to a user input, the application may be enlarged upward and downward, and a changed layout may be applied to the enlarged application as illustrated in FIG. 16B. For example, in a case where a location of an actor's face in an original movie image is configured as a ROI, a home screen module 200 may select a layout according to a size of the application when displaying the application. The home screen module 200 may display an image corresponding to the actor's face in the first region corresponding to the selected layout and a headline of an article related to the movie image in the second display region.

When the user input for changing the layout is received, the home screen module 200 may determine a layout to be changed based on layout information, and in a case where the determined layout includes a third display region 1602 and a fourth display region 1603 while the application is enlarged upward and downward as illustrated in FIG. 16B, the home screen module 200 may display the movie image in the third display region 1602 and the movie article in the fourth display region 1603. The application may be displayed while the size thereof is enlarged since the movie image displayed in the third region 1603 is larger than the image corresponding to the actor's face and an amount of the movie article displayed in the fourth display region 1604 is more than that of the headline. As described above, the arrangement of the application elements may be determined depending on the size of the displayed image or the amount of the displayed text before the application elements are displayed, and a rule for the arrangement of the application elements may be described in attribute information within the application data.

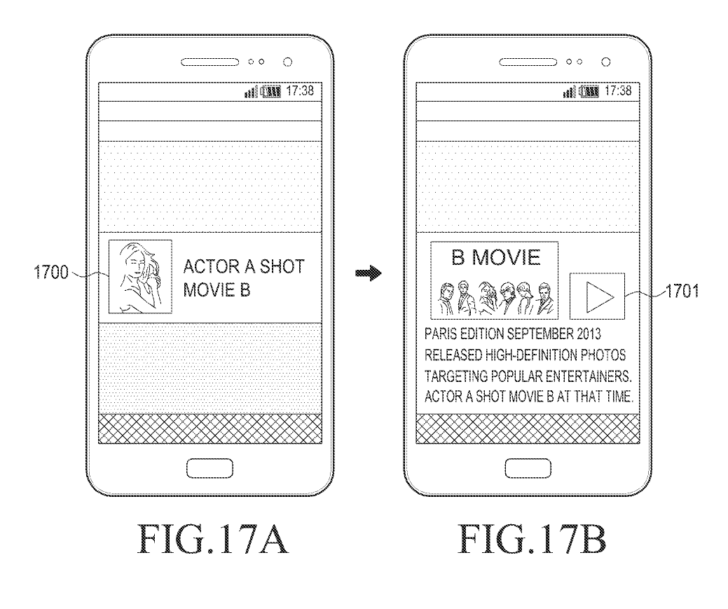

Referring to FIGS. 17A and 17B, when a user input is received while an application is displayed as illustrated in FIG. 17A, a home screen module 200 may change the layout of the application to a layout in which three application elements are arranged as illustrated in FIG. 17B. For example, when the user input is detected in a region 1700 in which an actor image is displayed as illustrated in FIG. 17A, the home screen module 200 may display video reproduction link information capable of reproducing a video related to movie shooting as an icon 1701 together with a movie image and a movie article as illustrated in FIG. 17B. The video reproduction icon 1701 may also be displayed in a hyperlink form. The corresponding video reproduction link information may be a link of a web page stored in advance in application data or a link of a video file related to the application data within an electronic device 101. The electronic device 101 analyzes the movie image or the movie article and creates a link for a video file related to the analyzed movie image or article among video files stored therein, which makes it possible to apply the link of the video file to the layout. A rule for the arrangement of the application elements may be described in attribute information within the application data.

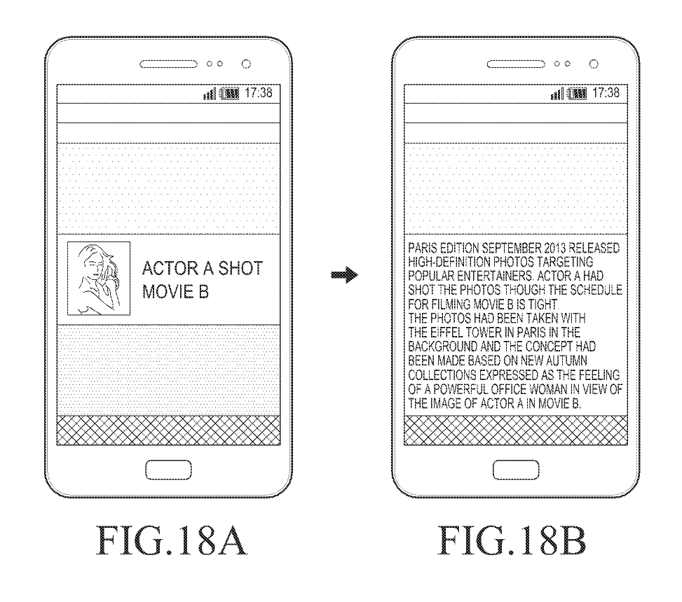

Referring to FIGS. 18A and 18B, when a user input is received while an application including two application elements is displayed as illustrated in FIG. 18A, a home screen module 200 may enlarge and display a specific application element as illustrated in FIG. 18B. For example, the home screen module 200 may enlarge the application according to the user input, and may display only text other than images in the enlarged display region according to an amount of the texts to display. The home screen module 200 may display a detailed article for the headline “Actor A shoots movie B” in the enlarged display region. A rule for the arrangement of the application elements may be described in attribute information within the application data.

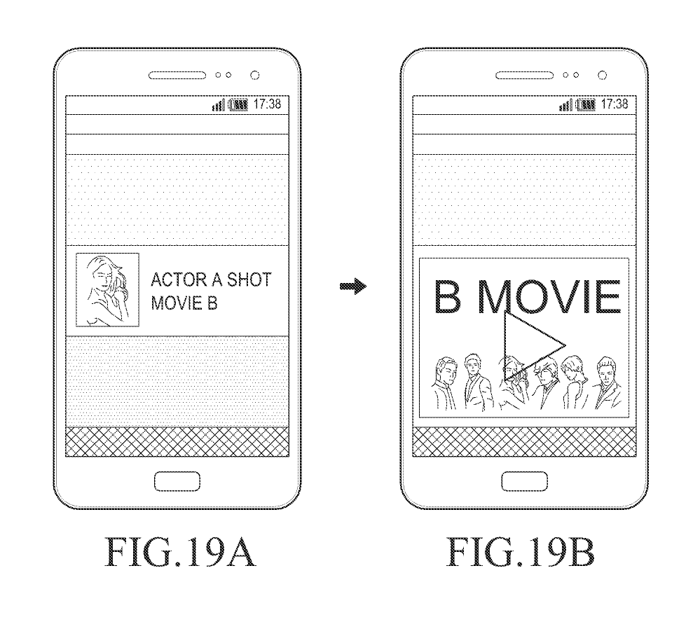

Referring to FIGS. 19A and 19B, when a user input is received while an application including two application elements is displayed as illustrated in FIG. 19A, a home screen module 200 may enlarge and display a new application element as illustrated in FIG. 19B. For example, the home screen module 200 may enlarge the application according to the user input, and may display video reproduction link information capable of reproducing a video file in the enlarged display region. When an input for reproducing a video file is entered by a user, the home screen module 200 may execute an application which can reproduce the video file. If the video reproduction link information corresponds to a video player, the home screen module 200 may reproduce and display the video in the display region without executing a separate application. A rule for the arrangement of the application elements may be described in attribute information within the application data.

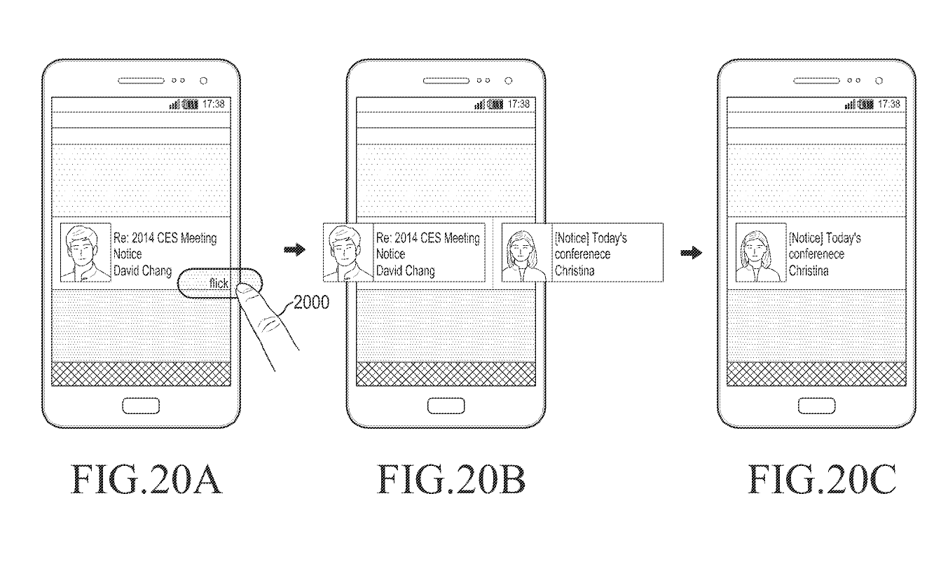

Referring to FIGS. 20A-20C, when a scroll input 2000 is received while an application configured with a first image and a first text is displayed as illustrated in FIG. 20A, a home screen module 200 may convert an application screen in a direction corresponding to the scroll to display a second image and a second text as illustrated in FIGS. 20B and 20C. The user input may be a scroll input such as a flick. For example, when a rightward scroll input is entered while an image of David Chang is displayed in a first display region and an e-mail sent by David Chang is displayed in a second display region as illustrated in FIG. 20A, the home screen module 200 may display an image of Christina in a third display region and an e-mail sent by Christina in a fourth display region while converting the application screen as illustrated in FIGS. 20B and 20C. The image of David Chang and Christina may be an image included in the e-mail or contact information of David Chang and Christina. Furthermore, if there is history in which a photo application designates the face of David Chang and Christina, the image of David Chang and Christina may be an image corresponding to the corresponding history or an image of David Chang and Christina received together with the e-mail. A rule for the arrangement of the application elements may be described in attribute information within the application data.

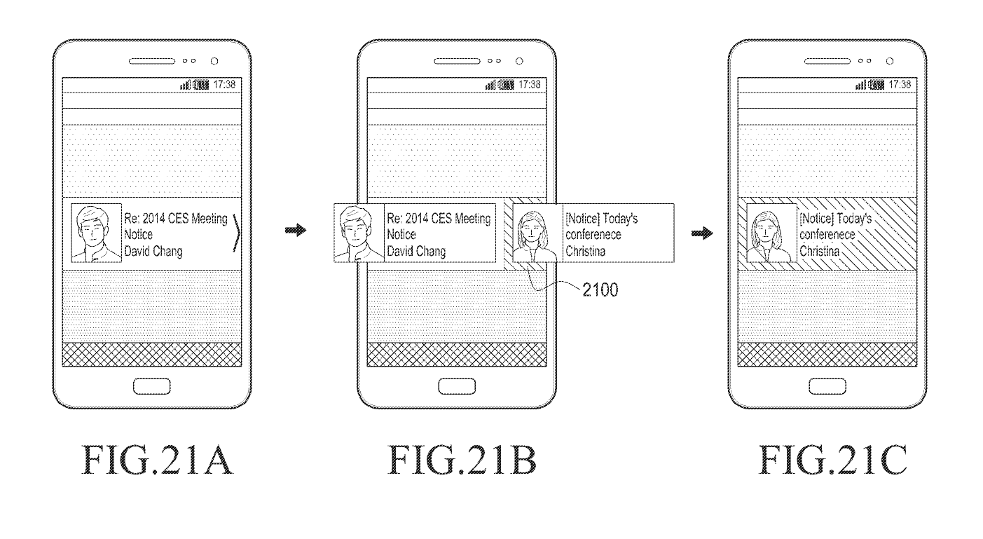

Referring to FIGS. 21A-21C, when a scroll input is received while an application configured with a first image, a first section of text, and a first background image is displayed as illustrated in FIG. 21A, a home screen module 200 may convert an application screen in a direction corresponding to the scroll to display a second image, a second section of text, and a second background image 2100 as illustrated in FIGS. 21B and 21C. For example, the home screen module 200 may display an e-mail sent by David Chang on a green background image as illustrated in FIG. 21A and an e-mail sent by Christina on a red background image as illustrated in FIG. 21B. The color may be displayed with reference to various options for an e-mail such as urgent information for an e-mail, a presence or absence of a user's reply, and an official document. The options may be automatically determined and designated by an e-mail application, or may be directly selected and designated by a user. A rule for the arrangement of the application elements may be described in attribute information within the application data.

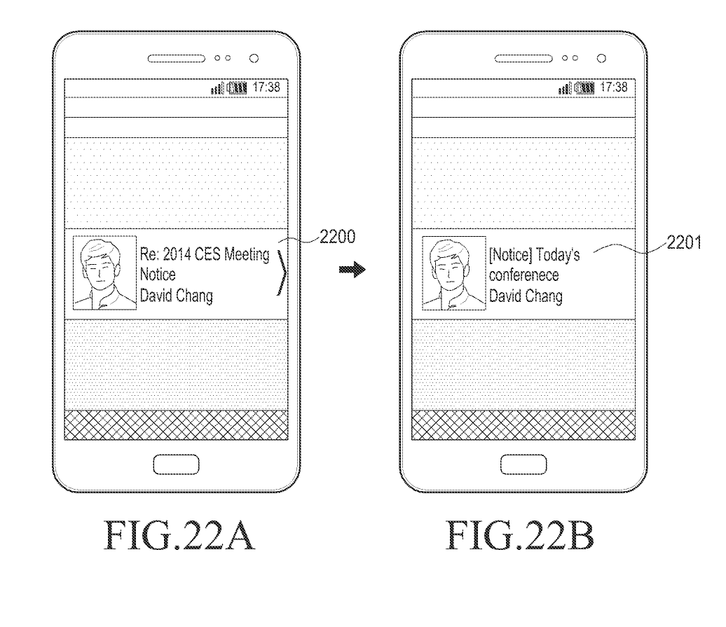

Referring to FIGS. 22A-22B, when a scroll input is received while an application configured with a first image and a first text 2200 is displayed as illustrated in FIG. 22A, a home screen module 200 may convert an application screen in a direction corresponding to the scroll to display the first image and a second text 2201 as illustrated in FIG. 22B. For example, as illustrated in FIG. 22B, the home screen module 200 may display an image for David Chang in a first display region and another e-mail sent by David Chang in a second display region. A rule for the arrangement of the application elements may be described in attribute information within the application data.

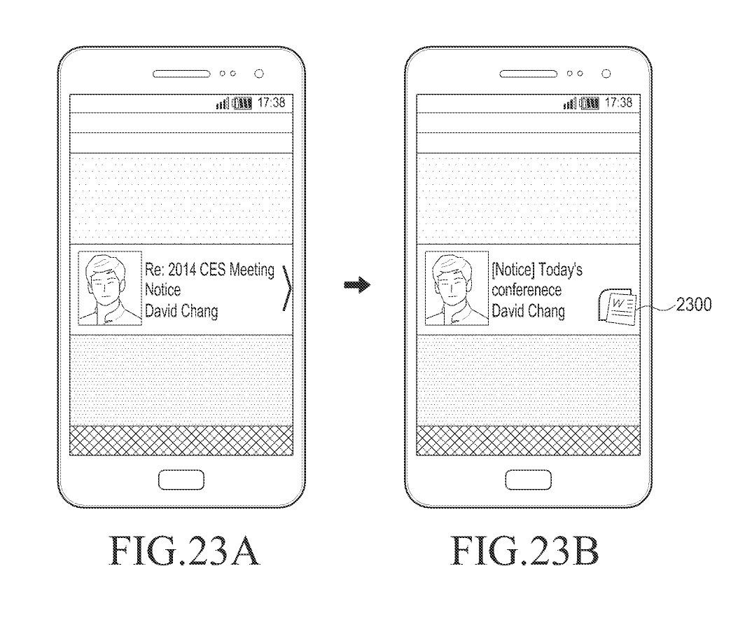

Referring to FIGS. 23A-23B, when a scroll input is received while an application configured with a first image and a first text is displayed as illustrated in FIG. 23A, a home screen module 200 may convert an application screen in a direction corresponding to the scroll to display the first image, a second text, and a first attached file as illustrated in FIG. 23B. For example, as illustrated in FIG. 23B, the home screen module 200 may display an image for David Chang, change “Re” 2014 CES Meeting Notice” to “[Notice] Today's conference” among e-mails sent by David Chang, and display an icon 2300 for the attached file related to “[Notice] Today's conference” together with the image. Accordingly, when an input for opening the attached file is entered, the home screen module 200 may display contents of the attached file on the application. A rule for the arrangement of the application elements may be described in attribute information within the application data.

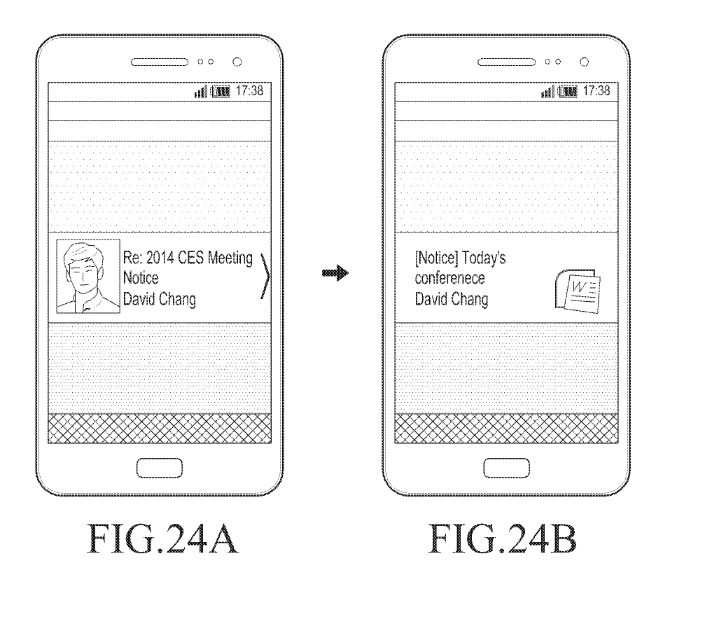

Referring to FIGS. 24A-24B, when a scroll input is received while an application configured with a first image and a first text is displayed as illustrated in FIG. 24A, a home screen module 200 may convert an application screen in a direction corresponding to the scroll to display a second text and a first attached file as illustrated in FIG. 24B. For example, as illustrated in FIG. 24B, the home screen module 200 may delete the image for David Chang, and may display an icon for an attached file related to “[Notice] Today's conference” together with “[Notice] Today's conference”. Accordingly, when an input for opening the attached file is entered, the home screen module 200 may display contents of the attached file on the application. A rule for the arrangement of the application elements may be described in attribute information within the application data.

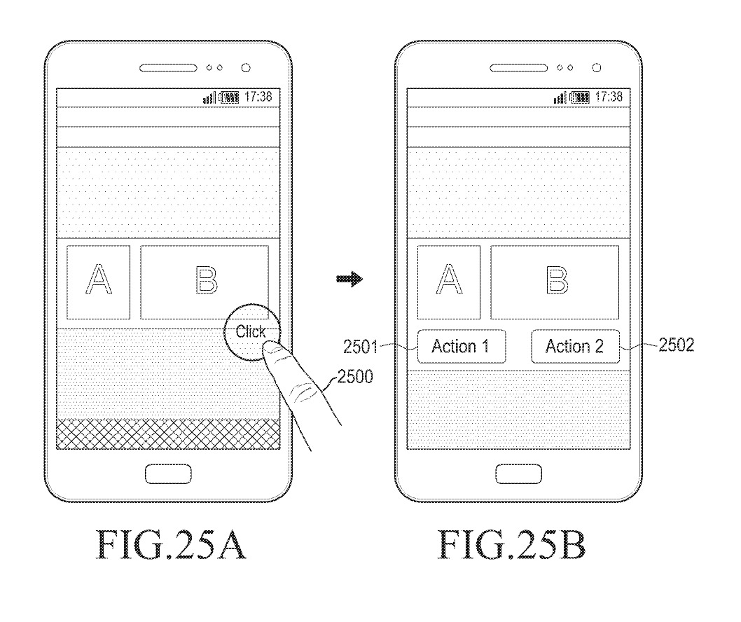

FIGS. 25A and 25B illustrate a method of displaying application elements depending on a user input according to an embodiment of the present disclosure.

Referring to FIGS. 25A and 25B, when a user input 2500 is received while an application including an application element A and an application element B is displayed as illustrated in FIG. 25A, a home screen module 200 may display a first action button 2501 related to the application element A and a second action button 2502 related to the application element B together with the two application elements as illustrated in FIG. 25B. The action buttons may be buttons capable of executing processes related to the application elements, and may be, for example, a button for executing a process such as a telephone call, an SMS, chatting, or the like. When a user clicks the action button, the home screen module 200 may execute a process corresponding to the clicked action button, and may store data related to the executed process. Such an action button may be created after or before the user input.

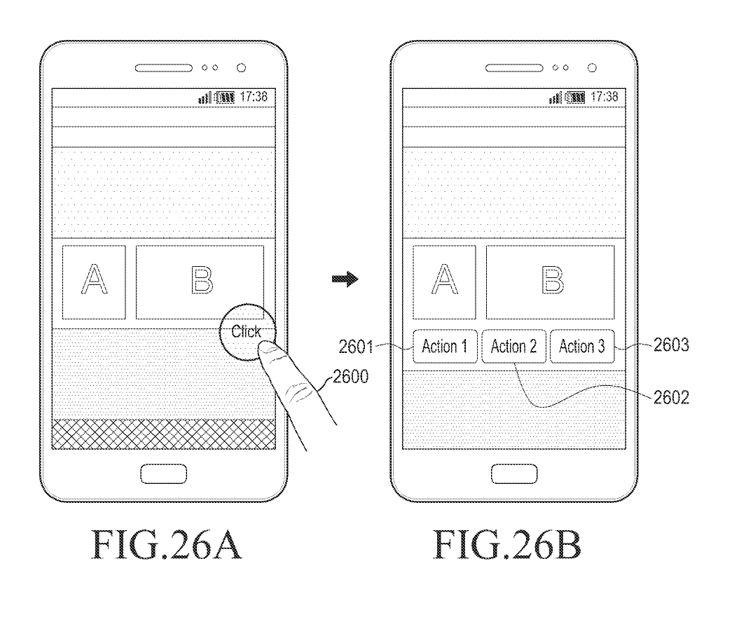

FIGS. 26A and 26B illustrate a method of displaying action elements of an application depending on a user input according to an embodiment of the present disclosure.

Referring to FIGS. 26A and 26B, when a user input 2600 is received while an application including an application element A and an application element B is displayed as illustrated in FIG. 26A, a home screen module 200 may display three action buttons including a first action button 2601, a second action button 2602, and a third action button 2603 as illustrated in FIG. 26B. The number of action buttons may vary depending on contents or the type of a dynamic application, and there is no restriction on the number of action buttons that may be provided.

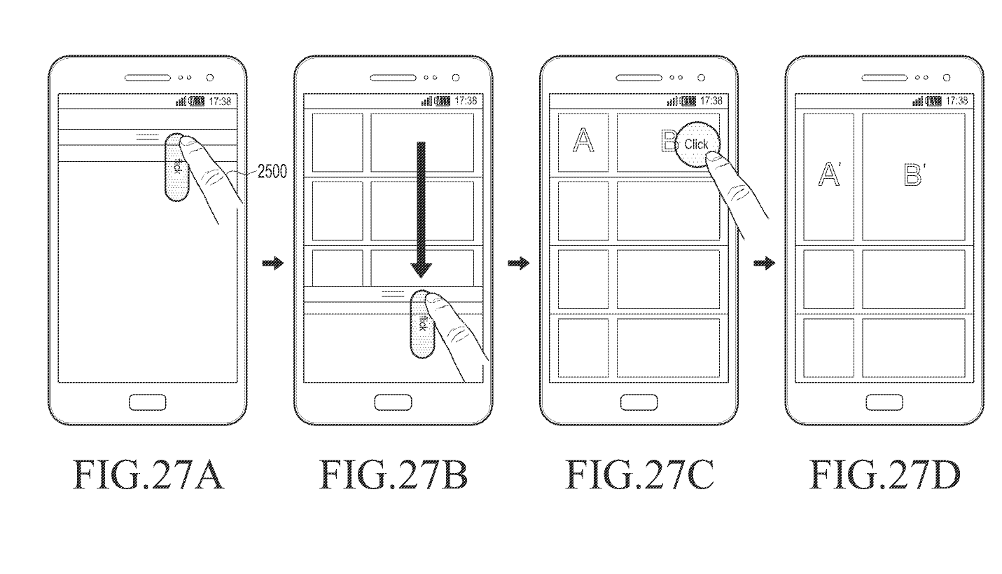

FIGS. 27A, 27B, 27C, and 27D illustrate a method of displaying action elements of an application depending on a user input according to various embodiments of the present disclosure.

Referring to FIGS. 27A-27D, an application may be displayed on a notification screen. For example, as illustrated in FIG. 27A, when a user input 2500 for enlarging the notification screen is entered, the home screen module 200 may enlarge the notification screen including a plurality of applications in a direction corresponding to the user input 2500, and may display the enlarged notification screen as illustrated in FIG. 27B.

When a user input is entered for an application including an application element A and an application element B among the plurality of displayed applications as illustrated in FIG. 27C, the home screen module 200 may display an application element A′ and an application element B′ while enlarging the application as illustrated in FIG. 27D.

Furthermore, since a size of a region for displaying the application on the notification screen or lock screen has been determined, the home screen module 200 may decrease an amount of content to be displayed on the application or transform the content.

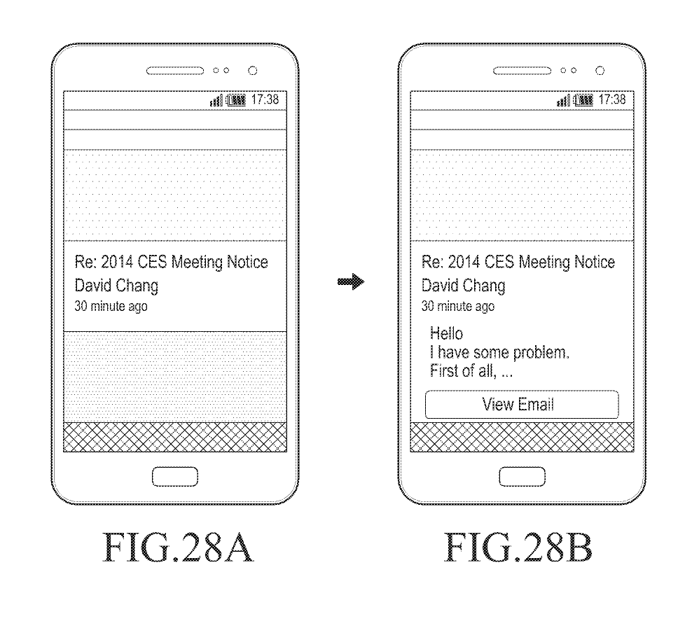

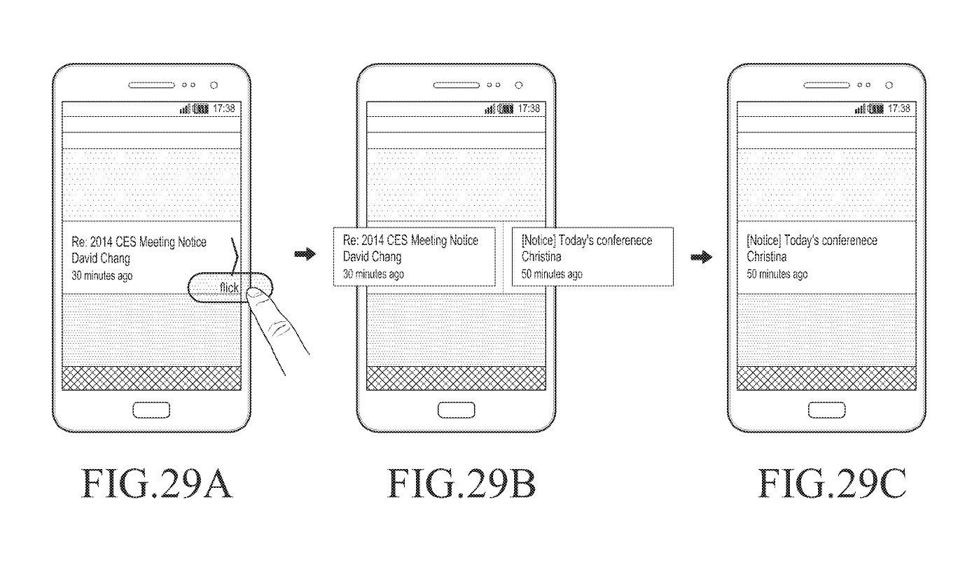

FIGS. 28A to 29C illustrate methods of displaying application elements depending on a user input according to an embodiment of the present disclosure.

Referring to FIGS. 28A-28B, a home screen module 200 may display an application for displaying a title of an e-mail, a sender, and a sending time. When a user input is entered, the home screen module 200 may additionally display contents of the e-mail and a View E-mail button capable of identifying detailed information on the e-mail together with the title of the e-mail, the sender, and the sending time while enlarging the application as illustrated in FIG. 28B.

Referring to FIGS. 29A-29C, the home screen module 200 may display one of a plurality of e-mails and an identifier for notifying that there are e-mails provided from different application providers in one display region.

When a flick input is entered for the displayed identifier, the home screen module 200 may convert the application display region in a direction corresponding to the flick input, and may display e-mails other than the displayed e-mail among the plurality of e-mails as illustrated in FIGS. 29B and 29C.

Accordingly, the home screen module 200 may differently express the application displaying one e-mail and the application displaying the plurality of e-mails by displaying the identifier.

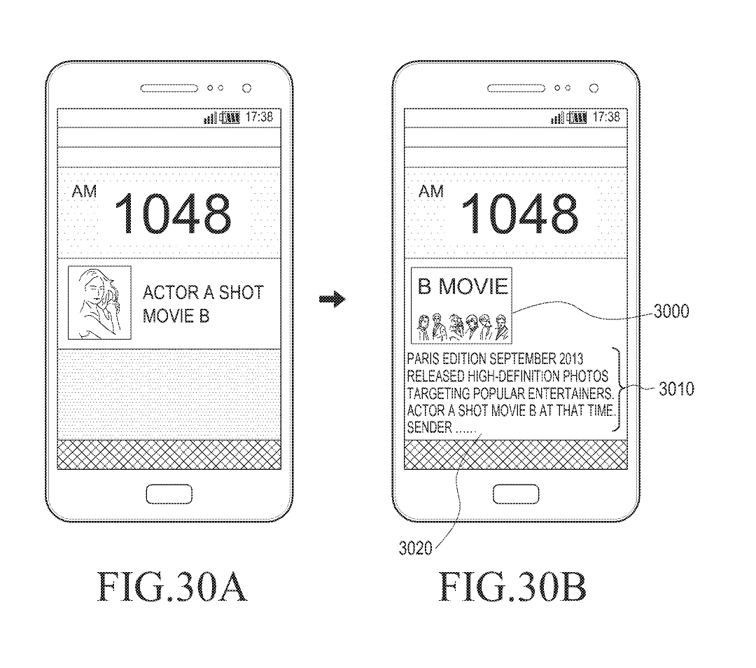

FIGS. 30A and 30B illustrate a method of displaying application elements depending on a user input in a lock screen state according to an embodiment of the present disclosure.

Referring to FIGS. 30A-30B, when a user input is entered while an application is displayed on a lock screen as illustrated in FIG. 30A, a home screen module 200 may display application elements including a movie image 3000, a movie article 3010, and sender information 3020 while enlarging the application as illustrated in FIG. 30B. In the various embodiments of the present disclosure, some content may be displayed as security characters including a special character “*” on the lock screen.

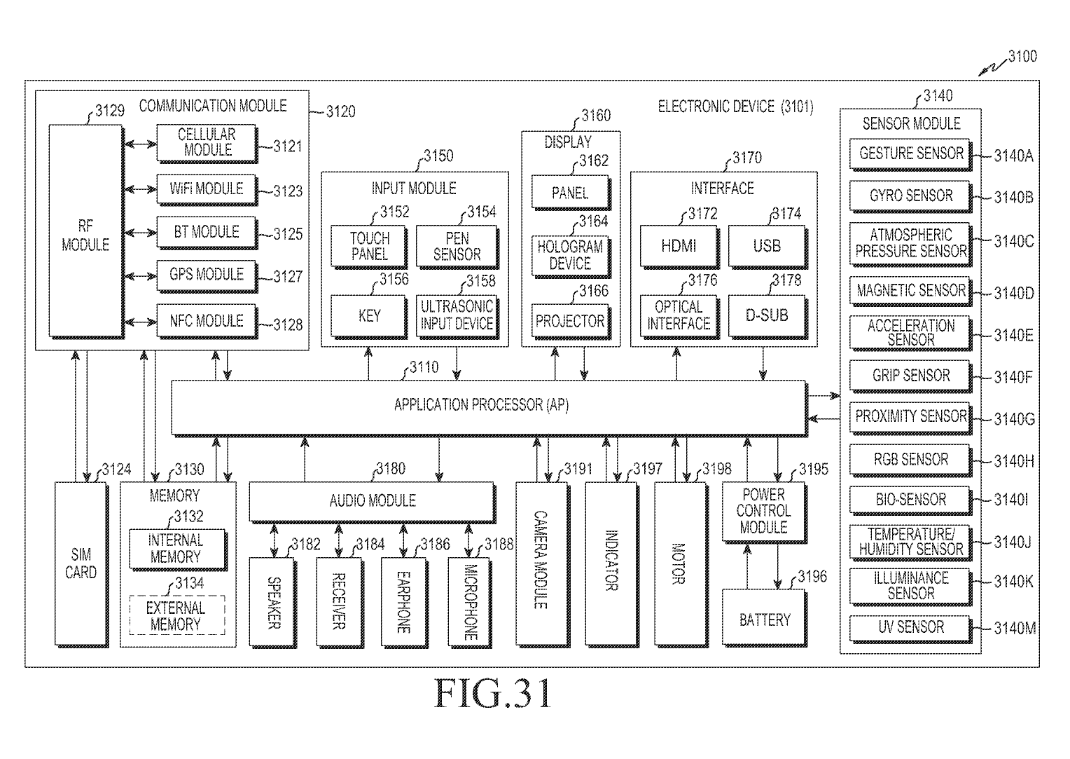

FIG. 31 is a block diagram of an electronic device 3101 according to an embodiment of the present disclosure.

Referring to FIG. 31, the electronic device 3101 may configure, for example, all or some of the electronic device 101 illustrated in FIG. 1. Referring to FIG. 31, the electronic device 3101 may include at least one Application Processor (AP) 3110, a communication module 3120, a Subscriber Identification Module (SIM) card 3124, a memory 3130, a sensor module 3140, an input device 3150, a display 3160, an interface 3170, an audio module 3180, a camera module 3191, a power management module 3195, a battery 3196, an indicator 3197, and a motor 3198.

The AP 3110 may control a plurality of hardware or software components connected to the AP 3110 by driving an operating system or an application program, process various data including multimedia data, and perform calculations. The AP 3110 may be implemented by, for example, a System on Chip (SoC). According to one embodiment, the AP 3110 may further include a Graphic Processing Unit (GPU).

The communication module 3120 (e.g., the communication interface 160) may perform data transmission/reception in communication between the electronic device 3101 (e.g., the electronic device 101) and other electronic devices (e.g., the electronic device 104 and the server 106) connected thereto through a network. The communication module 3120 may include a cellular module 3121, a Wi-Fi module 3123, a BT module 3125, a GPS module 3127, an NFC module 3128, and a Radio Frequency (RF) module 3129.

The cellular module 3121 may provide a voice call, a video call, a message service, or an interne service through a communication network (e.g., LTE, LTE-A, CDMA, WCDMA, UMTS, WiBro, GSM, or the like). Furthermore, the cellular module 3121 may distinguish and authenticate electronic devices within a communication network using a subscriber identification module (e.g., the SIM card 3124). The cellular module 3121 may perform at least some of the functions which the AP 3110 may provide. For example, the cellular module 3121 may perform at least some multimedia control functions.

The cellular module 3121 may include a Communication Processor (CP). Furthermore, the cellular module 3121 may be implemented by, for example, an SoC. Although the elements such as the cellular module 3121 (e.g., the communication processor), the memory 3130, and the power management module 3195 are illustrated to be separate from the AP 3110 in FIG. 31, the AP 3110 may be implemented to include at least one of the above described elements (e.g., the cellular module 3121) according to one embodiment.

The AP 3110 or the cellular module 3121 (e.g., the communication processor) may load commands or data received from at least one of a non-volatile memory and other elements connected thereto to a volatile memory, and may process the loaded commands or data. Furthermore, the AP 3110 or the cellular module 3121 may store data received from at least one of other elements or created by at least one of other elements in a non-volatile memory.

The Wi-Fi module 3123, the BT module 3125, the GPS module 3127, and the NFC module 3128 may include, for example, a processor for processing data transmitted/received through the corresponding module. Although the cellular module 3121, the Wi-Fi module 3123, the BT module 3125, the GPS module 3127, and the NFC module 3128 are illustrated as individual blocks in FIG. 31, at least some (e.g., two or more) of the cellular module 3121, the Wi-Fi module 3123, the BT module 3125, the GPS module 3127, and the NFC module 3128 may be included within one Integrated Chip (IC) or one IC package. For example, at least one (e.g., a communication processor corresponding to the cellular module 3121 and a Wi-Fi processor corresponding to the Wi-Fi module 3123) processor corresponding to the cellular module 3121, the Wi-Fi module 3123, the BT module 3125, the GPS module 3127, and the NFC module 3128, respectively, may be implemented as one SoC.

The RF module 3129 may transmit/receive data, for example, an RF signal. Although not illustrated, the RF module 3129 may include, for example, a transceiver, a Power Amp Module (PAM), a frequency filter, a Low Noise Amplifier (LNA) or the like. Furthermore, the RF module 3129 may further include a component, such as a conductor, a conductive wire, or the like, for transmitting/receiving an electromagnetic wave in a free space in wireless communication. Although the cellular module 3121, the Wi-Fi module 3123, the BT module 3125, the GPS module 3127, and the NFC module 3128 are illustrated to share one RF module 3129 in FIG. 31, at least one of the cellular module 3121, the Wi-Fi module 3123, the BT module 3125, the GPS module 3127, and the NFC module 3128 may transmit/receive the RF signal through a separate RF module.

The SIM card 3124 may be a card including a subscriber identification module, and may be inserted into a slot formed in a particular portion of the electronic device. The SIM card 3124 may include unique identification information (e.g., Integrated Circuit Card IDentifier (ICCID)) or subscriber information (e.g., International Mobile Subscriber Identity (IMSI)).

The memory 3130 (e.g., the memory 130) may include an internal memory 3132 or an external memory 3134. The internal memory 3132 may include at least one of a volatile memory (e.g., a Dynamic Random Access Memory (DRAM), a Static RAM (SRAM), a Synchronous Dynamic RAM (SDRAM), or the like) or a non-volatile memory (e.g., a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a NAND flash memory, a NOR flash memory, or the like).

According to one embodiment, the internal memory 3132 may be a Solid State Drive (SSD). The external memory 3134 may further include a flash drive, for example, a Compact Flash (CF), a Secure Digital (SD), a Micro Secure Digital (Micro-SD), a Mini Secure Digital (Mini-SD), an extreme Digital (xD), a memory stick or the like. The external memory 3134 may be functionally connected with the electronic device 3101 through various interfaces. According to one embodiment, the electronic device 3101 may further include a storage device (or storage medium) such as a hard disk drive.

The sensor module 3140 may measure a physical quantity or detect an operation state of the electronic device 3101, and may convert the measured or detected information to an electronic signal. The sensor module 3140 may include at least one of, for example, a gesture sensor 3140A, a gyro sensor 3140B, an atmospheric pressure sensor 3140C, a magnetic sensor 3140D, an acceleration sensor 3140E, a grip sensor 3140F, a proximity sensor 3140G, a color sensor 3140H (e.g., a Red/Green/Blue (RGB) sensor), a bio-sensor 3140I, a temperature/humidity sensor 3140J, an illumination sensor 3140K, and an Ultra Violet (UV) sensor 3140M. Additionally or alternatively, the sensor module 3140 may include, for example, a E-nose sensor (not illustrated), an ElectroMyoGraphy (EMG) sensor (not illustrated), an ElectroEncephaloGram (EEG) sensor (not illustrated), an ElectroCardioGram (ECG) sensor (not illustrated), an InfraRed (IR) sensor, an iris sensor (not illustrated), a fingerprint sensor, and the like. The sensor module 3140 may further include a control circuit for controlling one or more sensors included therein.

The input device 3150 may include a touch panel 3152, a (digital) pen sensor 3154, a key 3156, or an ultrasonic input device 3158. The touch panel 3152 may recognize a touch input through at least one of, for example, a capacitive type, a resistive type, an infrared type, and an acoustic wave type. The touch panel 3152 may further include a control circuit. In the capacitive type, physical contact or proximity recognition is possible. The touch panel 3152 may also further include a tactile layer. In this case, the touch panel 3152 may provide a tactile reaction to a user.

The (digital) pen sensor 3154 may be implemented, for example, using a method identical or similar to a method of receiving a touch input of a user, or using a separate recognition sheet. The key 3156 may include, for example, a physical button, an optical key or keypad. The ultrasonic input device 3158 is a device which can detect an acoustic wave by a microphone (e.g., microphone 3188) of the electronic device 3101 through an input tool generating an ultrasonic signal to identify data and can perform wireless recognition. The electronic device 3101 may also receive a user input from an external device (for example, a computer or server) connected thereto, using the communication module 3120.

The display 3160 (e.g., the display 150) may include a panel 3162, a hologram device 3164, and a projector 3166. For example, the panel 3162 may be a Liquid Crystal Display (LCD) or an Active Matrix Organic Light Emitting Diode (AM-OLED). The panel 3162 may be implemented to be, for example, flexible, transparent, or wearable. The panel 3162 may also be configured as one module together with the touch panel 3152. The hologram device 3164 may show a stereoscopic image in the air by using interference of light. The projector 3166 may project light onto a screen to display an image. For example, the screen may be located inside or outside the electronic device 3101. The display 3160 may further include a control circuit for controlling the panel 3162, the hologram device 3164, or the projector 3166.

The interface 3170 may include, for example, a High-Definition Multimedia Interface (HDMI) 3172, a Universal Serial Bus (USB) 3174, an optical interface 3176, or a D-subminiature (D-sub) 3178. The interface 3170 may be included in, for example, the communication interface 160 illustrated in FIG. 1. Additionally or alternatively, the interface 290 may include, for example, a Mobile High-definition Link (MHL) interface, a Secure Digital (SD) card/Multi-Media Card (MMC) interface, or an Infrared Data Association (IrDA) standard interface.

The audio module 3180 may bilaterally convert a sound and an electronic signal. At least some elements of the audio module 3180 may be included in, for example, the input/output interface 140 illustrated in FIG. 1. The audio module 3180 may process voice information input or output through, for example, the speaker 3182, the receiver 3184, the earphones 3186, or the microphone 3188.

The camera module 3191 is a device which can photograph a still image and a moving image. The camera module 3191 may include one or more image sensors (e.g., a front sensor or a rear sensor), a lens (not illustrated), an Image Signal Processor (ISP) (not illustrated) or a flash (not illustrated) (e.g., an LED or xenon lamp).

The power management module 3195 may manage power of the electronic device 3100. Although not illustrated, the power management module 3195 may include, for example, a Power Management Integrated Circuit (PMIC), a charger Integrated Circuit (IC), or a battery or fuel gauge.

The PMIC may be mounted in, for example, an integrated circuit or an SoC semiconductor. A charging method may be classified into a wired charging method and a wireless charging method. The charger IC may charge a battery, and may prevent introduction of over-voltage or over-current from a charger. The charger IC may include a charger IC for at least one of the wired charging method and the wireless charging method. A magnetic resonance scheme, a magnetic induction scheme, or an electromagnetic scheme may be exemplified as the wireless charging method, and an additional circuit for wireless charging, such as a coil loop circuit, a resonance circuit, a rectifier circuit, and the like may be added.

The battery fuel gauge may measure, for example, a remaining quantity of the battery 3196, or a voltage, a current, or a temperature during the charging. The battery 3196 may store or generate electricity, and may supply power to the electronic device 3101 using the stored or generated electricity. The battery 3196 may include, for example, a rechargeable battery or a solar battery.

The indicator 3197 may display a particular status of the electronic device 3101 or a part thereof (for example, the AP 3110), for example, a booting status, a message status, a charging status, or the like. The motor 3198 may convert an electrical signal to a mechanical vibration. Although not illustrated, the electronic device 3101 may include a processing unit (e.g., GPU) for mobile TV support. The processing unit for the mobile TV support may process media data according to a standard of Digital Multimedia Broadcasting (DMB), Digital Video Broadcasting (DVB), media flow, or the like.

The aforementioned elements of the electronic device according to various embodiments of the present disclosure may be configured with one or more components, and the name of the corresponding element may vary depending on a type of the electronic device. The electronic device according to the various embodiments of the present disclosure may include at least one of the aforementioned elements or may further include other additional elements, or some of the aforementioned elements may be omitted. Furthermore, some of the elements of the electronic device according to the various embodiments of the present disclosure may be combined to form a single entity, and thus, may equivalently execute functions of the corresponding elements prior to the combination.

The term “module” used in the various embodiments of the present disclosure may refer to, for example, a unit including one or more combinations of hardware, software, and firmware. The “module” may be interchangeably used with a term such as unit, logic, logical block, component, or circuit. The “module” may be a minimum unit or a part of the integrally formed component. The “module” may be a minimum unit performing one or more functions or a part thereof. The “module” may be mechanically or electronically implemented. For example, the “module” according to the various embodiments of the present disclosure may include at least one of an Application-Specific Integrated Circuit (ASIC) chip, a Field-Programmable Gate Arrays (FPGA), and a programmable-logic device for performing operations which have been known or are to be developed hereinafter.

According to various embodiments, at least some of the devices (e.g., modules or functions thereof) or methods (e.g., operations) according to the various embodiments of the present disclosure may be implemented as, for example, instructions stored computer readable storage media in the form of programming modules When the instructions are executed by at least one processor (e.g., the processor 210), the at least one processor may perform functions corresponding to the instructions. The computer readable storage media may be, for example, the memory 130. At least some of the programming modules may be implemented (for example, executed) by, for example, the processor. At least some of the programming modules may include, for example, a module, a program, a routine, a set of instructions, or a process for performing one or more functions.

The computer-readable recording medium may include magnetic media such as a hard disk, a floppy disk, and a magnetic tape, optical media such as a Compact Disc Read Only Memory (CD-ROM) and a Digital Versatile Disc (DVD), magneto-optical media such as a floptical disk, and hardware devices specially configured to store and perform a program instruction (for example, programming module), such as a Read Only Memory (ROM), a Random Access Memory (RAM), a flash memory and the like. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa.

The module or the programming module according to various embodiments of the present disclosure may include one or more of the aforementioned components, or some of the components may be omitted or other additional components may be further included. The operations performed by the modules, the programming modules, or other elements according to the various embodiments of the present disclosure may be executed through a sequential, parallel, repeated, or heuristic method. Furthermore, some operations may be executed in a different order or may be omitted, or other operations may be added.

According to various embodiments, in the storage media storing the instructions, the instructions are configured to allow at least one processor to perform at least one operation when executed by the at least one processor, and the at least one operation may include an operation of selecting at least two content items at least partially based on setting information associated with the content and characteristics of an application displaying the content, and an operation of providing the selected at least two content items.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of using an electronic device, the method comprising:
selecting at least two content items at least partially based on setting information associated with the at least two content items and characteristics of an application displaying the content; and
providing the selected at least two content items.

2. The method of claim 1, wherein the providing of the selected at least two content items comprises:
transforming the selected at least two content items.

3. The method of claim 1, wherein the providing of the selected at least two content items comprises:
providing at least one other content item at least partially based on a configured condition.

4. The method of claim 1, wherein the providing of the selected at least two content items comprises:
changing a location of the at least two content items at least partially based on a configured condition.

5. The method of claim 1, wherein the providing of the selected at least two content items comprises:
providing different content at least partially based on a configured condition.

6. The method of claim 1, further comprising:
changing the characteristics of the application according to a change input for changing the characteristics of the application; and
changing the at least two content items at least partially based on the changed characteristics of the application.

7. The method of claim 6, wherein the changing of the characteristics of the application comprises changing a display layout of the application.

8. The method of claim 7, wherein the change input comprises an input for changing a size of the application and an input for turning a page of the application.

9. The method of claim 8, wherein the changing of the characteristics of the application comprises:
changing the size of the application when the input for changing the size of the application is received.

10. The method of claim 8, wherein the changing of the characteristics of the application comprises:
turning the page of the application when the input for turning the page of the application is received.

11. The method of claim 7, wherein the changing of the at least two content items comprises:
changing an arrangement of the content displayed on the application according to the changed characteristics of the application.

12. The method of claim 7, wherein the changing of the at least two content items comprises:
transforming the content displayed on the application according to the changed characteristics of the application.

13. The method of claim 7, wherein the characteristics of the application comprises a size of the application, display for the application on a lock screen, or display for the application on a notification screen.

14. The method of claim 1, wherein the setting information comprises at least one of display information for the content to be displayed on the application, action information for an executable action corresponding to an arrangement change of the content, attribute information used to change the content to be displayed on the application, and template type information including a type or the number of the content displayed on the application.

15. An electronic device comprising:
a display functionally connected with the electronic device and configured to display an application; and
a processor configured:
to select at least two content items at least partially based on setting information associated with the at least two content items and characteristics of an application displaying the content, and
to provide the selected at least two content items.

16. The electronic device of claim 15, wherein the processor transforms the selected at least two content items.

17. The electronic device of claim 15, wherein the processor provides at least one other content item at least partially based on a configured condition.

18. The electronic device of claim 15, wherein the processor changes a location of the at least two content items at least partially based on a configured condition.

19. The electronic device of claim 15, wherein the processor provides different content at least partially based on a configured condition.

20. The electronic device of claim 15, wherein the processor changes the characteristics of the application according to a change input for changing the characteristics of the application, and changes the at least two content items at least partially based on the changed characteristics of the application.

21. The electronic device of claim 20, wherein the processor changes a display layout of the application and changes the at least two content items at least partially based on the changed layout.

22. The electronic device of claim 20, wherein the change input comprises an input for changing a size of the application and an input for turning a page of the application.

23. The electronic device of claim 22, wherein the processor changes the size of the application when the input for changing the size of the application is received.

24. The electronic device of claim 22, wherein the processor turns the page of the application when the input for turning the page of the application is received.

25. The electronic device of claim 20, wherein the processor changes an arrangement of the at least two content items displayed on the application according to the changed characteristics of the application.

26. The electronic device of claim 20, wherein the processor transforms the at least two content items displayed on the application according to the changed characteristics of the application.

27. The electronic device of claim 20, wherein the characteristics of the application comprises at least one of a size of the application, display for the application on a lock screen, or display for the application on a notification screen.

28. The electronic device of claim 15, wherein the setting information comprises at least one of display information for the at least two content items to be displayed on the application, action information for an executable action corresponding to an arrangement change of the content, attribute information used to change the content to be displayed on the application, and template type information including a type or the number of the content displayed on the application.
